(19) United States
(12) Patent Application Publication
(10) Pub. No.: US 2009/0094045 A1
(43) Pub. Date: Apr. 9, 2009

(54) Method and system for determining the reliability of forensic interpretation

(76) Inventor: Mark W. Perlin, Pittsburgh, PA (US)

Correspondence Address: Ansel M. Schwartz;Attorney at Law, 201 N. Craig Street, Suite 304, Pittsburgh, PA, 15213, US

(21) Appl. No.: 11/973,583

(22) Filed: Oct. 9, 2007

(51) Int. Cl. G06Q 99/00

(52) U.S. Cl. 705/1

(57) ABSTRACT

The present invention pertains to a process for determining reliability of forensic interpretation methods. Specifically, the process comprises the steps of obtaining forensic data, a known feature, and a population of features; obtaining a forensic interpretation method that is applicable to the forensic data; applying the interpretation method to the forensic data to obtain an inferred feature; computing a match information statistic that determines a frequency of occurrence of a match between the inferred feature and the known feature relative to the population of features; and computing a numerical reliability statistic from the match information statistic to determine the reliability of the forensic interpretation method for legal admissibility in a court of law. This reliability determination is useful for validating a forensic interpretation method so that its results can be admitted as evidence in a court of law. Establishing reliability helps ensure that forensic evidence complies with F.R.E. 702, which requires that a method and the application of the method to data must be reliable in order to be admissible.

### FIELD OF THE INVENTION

The present invention pertains to a method for determining the reliability of forensic interpretation methods. More specifically, the present invention is related to performing a forensic interpretation that includes a match statistic, and analyzing these match values to characterize the reliability of the forensic interpretation. The present invention also pertains to a system related to this interpretation reliability.

### BACKGROUND OF THE INVENTION

For courtroom admissibility, Federal Rule of Evidence (FRE) 702 mandates the reliability of (a) data, (b) method, and (c) application of method to data. The “reliability” of each component is determined (according to jurisdiction) by the Frye (1923) or Daubert (1993) standard. Whereas Frye entails only general acceptance, Daubert also provides for a testable approach, whose error rate has been determined, and has been communicated by peer review dissemination. These Daubert criteria are typically met by conducting scientific validation studies that establish the reliability of an approach by testing it and determining an error rate.

Forensic STR data have undergone extremely rigorous scientific validation in this country, with validation studies of laboratory processes routinely introduced as courtroom evidence in order to establish admissibility. Similarly, the DNA science of interpreting and matching single source profiles is solidly grounded in the rigor of population genetics. Since there is only one correct designation of a pristine single source profile, concordance studies can compare (the theoretically identical) results of two different examiners.

However, interpretation of mixed or other uncertain DNA samples need not produce unambiguous results. Different laboratories follow different mixture interpretation guidelines. Moreover, different examiners within the same laboratory who are following the same guidelines often infer different STR profiles. Therefore, there is no concordance in current forensic practice on what constitutes a “correct” solution for mixtures or uncertain data. Thus, it is not possible to conduct an interpretation concordance study for mixtures or uncertain data in order to validate a casework interpretation method. But it is useful to have some way of testing the reliability of casework interpretation methods so that inferred profiles from DNA mixtures or uncertain data can be scientifically validated and admitted as legal evidence.

This application describes a general approach to scientifically validating DNA profiles derived from mixed or other uncertain DNA samples. Instead of conducting the usual concordance comparison (which is not possible), the approach described determines the amount of information present in the DNA match between an inferred DNA profile and a reference profile. By examining these numerical measures of match information, it becomes possible to assess the reliability of a mixture interpretation method.

This validation approach has been tested on uncertain DNA samples from a multiplicity of crime laboratories, each of whom uses its own interpretation methods. The specification describes how different interpretation methods produce different inferred profiles with varying match specificity. However, regardless of match information, once a lab's DNA interpretation method has been scientifically validated, its inferred profiles (and DNA matches that include those profiles) become admissible as reliable evidence in court.

The present invention describes a novel approach to scientifically validating a lab's guidelines for interpreting DNA mixtures or other uncertain data. The specification describes different examples of mixture interpretation guidelines used in forensic practice, and shows how these guidelines can all be validated as reliable methods. It also illustrates how the invention can be used for presenting DNA results in court. By scientifically validating the casework interpretation method that it uses for mixture or other uncertain data, a crime lab can go beyond the admissibility of just its validated DNA laboratory data, and also ensure the admissibility of its validated interpretation methods, inferred profiles and DNA matches.

### BRIEF SUMMARY OF THE INVENTION

The present invention pertains to a method for determining a reliability of a forensic interpretation method comprising the steps of obtaining forensic data, a known feature, and a population of features. Then there is the further step of obtaining a forensic interpretation method that is applicable to the forensic data. Then there is the further step of applying the interpretation method to the forensic data to obtain an inferred feature. Then there is the further step of computing a match information statistic that determines a frequency of occurrence of a match between the inferred feature and the known feature relative to the population of features. Then there is the further step of computing a numerical reliability statistic from the match information statistic to determine the reliability of the forensic interpretation method for legal admissibility in a court of law.

The present invention also pertains to a method for comparing forensic features comprising the steps of inferring a first forensic feature. Then there is the step of inferring a second forensic feature. Then there is the step of obtaining a population of features along with their frequencies of occurrence. Then there is the step of computing a first probability of a specific match between the first feature and the second feature. Then there is the step of computing a second probability of a random match between the first feature and the population of features. Then there is the step of forming a match information statistic as a ratio of the first probability and the second probability for identifying an individual through a distinguishing feature.

The present invention also pertains to a system that has a computer program stored on a computer readable medium comprising a first step computing a match information statistic that determines a frequency of occurrence of a match between an inferred feature and a known feature relative to a population of features, where the inferred feature is obtained by applying a forensic interpretation method to forensic data. Then there is a second step of computing a numerical reliability statistic from the match information statistic to determine the reliability of the forensic interpretation method for legal admissibility in a court of law.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1A shows a method for determining a reliability of a forensic interpretation method.

FIG. 1B shows a 50:50 mixture profile for PowerPlex 16 STR data on an ABI/310 DNA sequencer.

FIG. 1C shows a zoomed in schematic of the D5S818 locus data illustrating how a heterozygote genotype combined in equal amounts with a homozygous genotype produces a 3:1 peak height ratio.

FIG. 2 shows the interpretation method of “conservative” government review of uncertain mixture data, where the goal is to avoid overcalling the results, and shows that the inferred locus profile can report 0, 1 or 2 alleles.

FIG. 3 shows the interpretation method of “aggressive” private lab review of uncertain mixture data, where the goal is to try ruling out unlikely mixture combinations, and shows that the inferred locus profile reports a list of possible allele calls.

FIG. 4 shows the interpretation method of “objective” computer review where the goal is to preserve match information. In the parts of the figure, (A) shows genetic uncertainty produces STR profiles that have probabilities associated with each possible genotype, and (B) shows data uncertainty can similarly produce an STR profile genotype with a probability distribution of allele calls.

FIG. 5A shows conservative human review in a government laboratory infers all possible allele pairs [*, *], which completely fills the square and represents all possible individuals.

FIG. 5B shows that the known genotype is the allele pair [12, 12].

FIG. 6A shows that the inferred profile [*, *] includes all possible genotypes, which matches the known genotype [12, 12].

FIG. 6B shows that the relative frequency of the inferred profile is 100% of the population, which yields no useful match information (that is, MI=0).

FIG. 7 shows that second government reviewer B, “conservatively” interpreting the same STR case data, inferred a mixture profile at locus D5S818 of [12, *]. This result agrees with that of the first private lab reviewer following a more “aggressive” mixture interpretation protocol, producing a genotype set that matches 50% of the population, including the known profile [12, 12], with the information for matching 50% of 0.3.

FIG. 8 shows that the second private lab reviewer B “aggressively” inferred the two allele pairs [12, 12] and [12, 13]. Shown are fewer Punnett square entries, hence a lower relative population frequency and increased match information.

FIG. 9 shows that the TrueAllele “objective” computer review inferred only one answer, [12, 12], which exactly matches the known answer. Shown is the relative frequency of the correct inferred profile at 10% is the smallest possible, yielding maximal match information.

FIG. 10 shows that the “match strength” page of the www.trueallele.net web site shows how the individual locus match strengths add to the total match strength for the full profile. Since the inferred profile is being compared here against the true profile, the match strength values provide the match information (at each locus and for the full profile).

FIG. 11A shows a bar plot of the MI statistic for each pair of “conservative” reviews (A and B) inferred profiles. The eight cases are for two different pairs of contributors, each case having different mixture weights. The y-axis shows the match information statistic in log units.

FIG. 11B shows accuracy through the match information values for each case for the two “conservative” reviewers A and B. The average of these 16 values is shown.

FIG. 12A shows a bar plot of the MI statistic for the “conservative” reviewers (A and B) that now includes a bar showing the maximum attainable match information for the known profile.

FIG. 12B shows precision through the match information values for the “conservative” reviewers A and B, showing the MI differences between the inferred and true profiles. The spreadsheet calculated the average of these 16 MI differences as −5.41.

FIG. 13A shows a bar plot of the MI statistic for the “aggressive” reviewers (A and B), including a bar showing the maximum attainable match information for the known profile.

FIG. 13B shows reproducibility in an Excel spreadsheet for eight paired case reviews. For each case (row), Reviewers A and B inferred profiles having the MI scores shown (columns) for each case. The mean “m” column has the average value of the MI values recorded within each case row. The last two columns show the square deviation between the reviewer's MI and the average MI for that case. Also shown are the SS, average SS and the standard deviation results.

FIG. 14A shows a bar plot of the MI statistic for the four “objective” reviews (A, B, C, D) by the TrueAllele Casework computer, including a bar showing the maximum attainable match information for the known profile.

FIG. 14B shows validation results for different mixture interpretation methods using a set of Match Information statistics. The interpretation methods (rows) are government “conservative” and private lab “aggressive” human review, and TrueAllele “objective” computer review. The statistics (columns) are accuracy (average match information), precision (average loss of match information), and reproducibility (standard deviation within case).

### DETAILED DESCRIPTION OF THE INVENTION

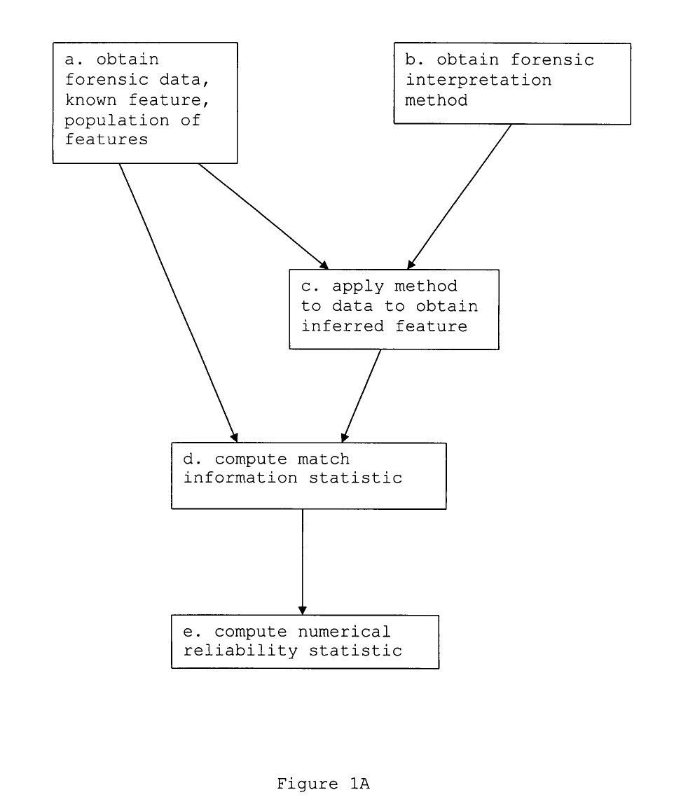

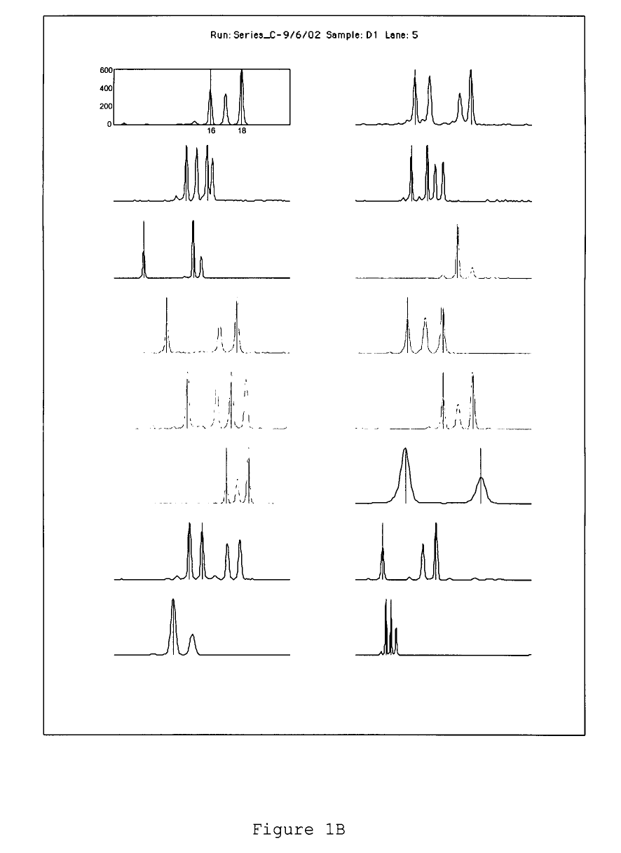

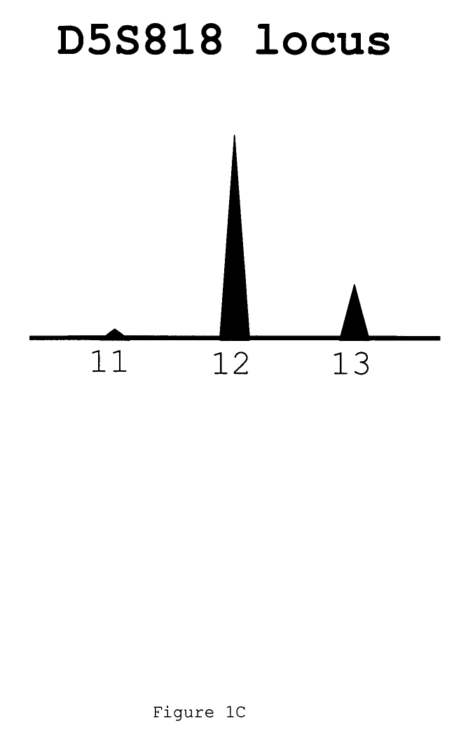

Referring now to the drawings wherein like reference numerals refer to similar or identical parts throughout the several views, and more specifically to FIG. 1A thereof, there is shown a method for determining a reliability of a forensic interpretation method comprising the steps (a) obtaining forensic data, a known feature, and a population of features, (b) obtaining a forensic interpretation method that is applicable to the forensic data, (c) applying the interpretation method to the forensic data to obtain an inferred feature, (d) computing a match information statistic that determines a frequency of occurrence of a match between the inferred feature and the known feature relative to the population of features, and (e) computing a numerical reliability statistic from the match information statistic to determine the reliability of the forensic interpretation method for legal admissibility in a court of law.

### Admissibility of Validated Interpretation Methods

For courtroom admissibility, Federal Rule of Evidence (FRE) 702 mandates the reliability of (a) data, (b) method, and (c) application of method to data. The “reliability” of each component is determined (according to jurisdiction) by the Frye (1923) or Daubert (1993) standard. Whereas Frye entails only general acceptance, Daubert also provides for a testable approach, whose error rate has been determined, and has been communicated by peer review dissemination. These Daubert criteria are typically met by conducting scientific validation studies that establish the reliability of an approach by testing it and determining an error rate.

Forensic STR data have undergone extremely rigorous scientific validation in this country, with validation studies of laboratory processes routinely introduced as courtroom evidence in order to establish admissibility. Similarly, the DNA science of interpreting and matching high quality single source profiles is solidly grounded in the rigor of population genetics. Since there is only one correct designation of a pristine single source profile, concordance studies can compare (the theoretically identical) results of two different examiners.

However, interpretation of mixed DNA samples or other uncertain data need not produce unambiguous results. Different laboratories follow different interpretation guidelines for mixtures, low copy number or other uncertain forensic DNA data. Moreover, different examiners within the same laboratory who are following the same guidelines often infer different STR profiles. Therefore, there is no concordance in current forensic practice on what constitutes a “correct” profile solution with mixtures or other uncertain data. Thus, it is not possible to conduct a concordance study in order to validate a method for interpreting mixtures or other uncertain data. But it is useful to have some way of testing the reliability of mixture interpretation methods so that inferred profiles from uncertain DNA data can be scientifically validated and admitted as legal evidence.

The present invention provides a general approach to scientifically validating DNA profiles inferred from mixtures or other uncertain data. Instead of conducting a concordance comparison (which is not possible), the invention determines the amount of information present in the DNA match between a profile inferred from uncertain data and a reference profile. By examining these numerical measures of match information, it becomes feasible to assess the reliability of a mixture interpretation method.

The specification describes testing of the novel validation invention on representative uncertain data obtained from mixed DNA samples from a multiplicity of crime laboratories, each of which uses its own interpretation method. This testing found that different interpretation methods produce different inferred profiles with varying match specificity. However, regardless of match information, once a lab's interpretation method has been scientifically validated, its inferred profiles (and DNA matches that include those profiles) become admissible as reliable evidence in a court of law.

The present invention introduces a novel method and system for scientifically validating a method (such as laboratory guidelines or a computer program) for interpreting DNA mixtures other uncertain forensic data. The specification describes different mixture interpretation methods currently used in forensic practice, and shows how these methods can all be validated as reliable methods using the invention. This specification describes how the invention can be used for presenting results inferred from DNA evidence in court. By scientifically validating the casework interpretation method that it uses, a crime lab can go beyond the admissibility of just its validated DNA laboratory data, and also ensure the admissibility of its validated interpretation methods, inferred profiles and DNA matches.

### DNA Mixture Interpretation Admissibility

For scientific evidence to be admissible in court of law, it must be reliable. The Federal Rules of Evidence (FRE) Rule 702 requires that (i) the underlying data, (ii) the method of interpreting the data, and (iii) the application of this method to the data must all be reliable.

The older Frye 1923 ruling (1923) defined the reliability of expert evidence as general acceptance by the scientific community. This standard can inadvertently institutionalize junk science, or block the introduction of better science. Therefore the more recent (and widely embraced) Daubert 1993 ruling (1993) added to this general acceptance criterion four additional tests to help a judge assess the underlying scientific merit of the proffered evidence. These Daubert prongs are:
(1) Testable. Is the method inherently testable, and has it been tested?
(2) Error rate. Is it possible to determine error rate of the method, and has this error rate been determined?
(3) Peer review. Has the method been disseminated to the relevant scientific community in ways that foster critical review?
(4) Standards. Have standards been established for the use of the method?
   While no one test is required, Daubert provides useful criteria for ascertaining scientific reliability.

The science of DNA identification coevolved with the legal Daubert standard (Faigman, Kaye et al. 2002). The forensic emphasis largely centered on the reliability of DNA laboratory data and the underlying population statistics. However, little attention was paid to the method of interpreting these data. With clean single source reference profiles, reliable data can produce only one correct answer, and so concordance between interpretations is sufficient for demonstrating reliability. Such concordance studies form the basis for validating the interpretation of reference STR profiles (Kadash, Kozlowski et al. 2004; NDIS 2005).

However, the situation is not so clear when interpreting uncertain DNA evidence, such as mixtures or compromised samples. Different laboratories use different methods of interpretation for mixtures or other uncertain data. Moreover, different people following the same casework (e.g., mixture) interpretation protocol on the same data can derive different STR profiles. No concordance study is therefore possible since discordant, but valid, inferred mixture profiles cannot be meaningfully compared. Hence there is a need for a general validation approach, which can establish the reliability of STR mixture interpretation in accordance with FRE 702 and the Frye and Daubert requirements.

It is reasonable to question whether DNA mixture or other uncertain DNA evidence is currently admissible in American courts under FRE 702 (Perlin 2006). Certainly the underlying laboratory data can be demonstrated as reliable using established STR validation procedures (DNA Advisory Board 2000; Butler 2006). However, DNA interpretation experts have not validated the reliability of their interpretation methods for mixtures or other uncertain data, nor the reliability of how these methods are applied to their STR data.
Uncertain DNA evidence, such as mixtures, currently fails the general acceptance test of both Frye and Daubert, since there are no generally accepted methods for interpreting mixed stains. Additionally, mixture evidence also fails all four scientific Daubert criteria:
(1) Testable. Inferred mixture profiles have not been tested for reliability, since the usual concordance comparisons cannot work.
(2) Error rate. DNA laboratories generally do not determine nor publish their mixture interpretation error rates.
(3) Peer review. Laboratories tend to not share their mixture interpretation guidelines, and many consider their interpretation methods to be confidential.
(4) Standards. Mixture interpretation standards do not exist, since each group uses its own interpretation protocols. Moreover, imposing one group's standards (Gill, Brenner et al. 2006) on other practitioners without a rigorous scientific theory would be harmful to both science and the law.

The legal weakness of unvalidated scientific methods has not been lost on the defense bar. Recent articles in the legal defense literature provide recipes for decimating unvalidated methods. For example, in their Champion article “Evaluating and Challenging Forensic Identification Evidence,” Tobin and Thompson describe the successful admissibility challenge to the unvalidated Comparative Bullet Lead and Analysis (CBLA) method, and extend it into a general strategy, specifically targeting the potential weaknesses of DNA evidence (Tobin and Thompson 2006). The authors use four phases of forensic comparison to identify vulnerable targets for legal attack, when considering incompletely validated interpretation methods. As applied to DNA evidence, these phases are:
(1) infer a DNA profile from uncertain data
(2) match the profile with a suspect profile
(3) assess the relative frequency of the profile
(4) draw conclusions

For DNA analysis, the matching methods of Phase 2 are largely agreed upon for simple data (though more work is required for complex data), the population statistics of Phase 3 has been adequately addressed by the courts, and the conclusions of Phase 4 are largely up to the finders of fact (i.e., the judge or the jury). It is Phase 1, the inferred profile from uncertain data such as mixtures, that is currently without validation support. In order to introduce DNA profiles from mixtures or other uncertain data as evidence without fear of a successful defense admissibility challenge, the DNA expert must provide a scientific validation of their interpretation method for mixed or uncertain data to establish its reliability.

This invention provides a scientific approach to validating DNA interpretation methods for mixtures and other uncertain evidence. This approach does not rely on concordance studies, which are not scientifically meaningful in this context. Rather, the invention associates with each inferred mixture profile a “match information” value that indicates how strongly the inferred profile matches the true profile. (The true profile can be known in advance in a scientific study, or it can be determined from a legal outcome such as a confirmed match with a guilty verdict.) The specification details how to use this match information number to statistically examine the efficacy (e.g., accuracy and precision) and the reproducibility of inferred profiles from mixture or other uncertain data. By conducting these uncertain profile match information calculations (using custom software or a standard spreadsheet), a DNA laboratory can rapidly and effectively assess the reliability of its interpretation methods for mixtures and other uncertain data. This quantitative assessment is sufficient to scientifically validate the laboratory's interpretation method (and the application of this method to its uncertain STR data), and thereby overcome an admissibility challenge.

### Different Mixture Interpretation Methods

The specification provides an extended example of alternative interpretation methods and resulting profiles on the same data. The example uses a 50:50 mixture data sample that was presented together with a reference sample in a mock sexual assault study, as previously described (Perlin 2003; Perlin 2005). The mixture sample data (FIG. 1B) shows the peaks for this 50:50 mixture. In a focused schematic of the D5S818 locus data (FIG. 1C), it is clear how the [12, 13] reference heterozygote combined in equal amounts with the [12, 12] unknown genotype produces a 3:1 peak height ratio. The forensic examiner's task is to accurately infer the [12, 12] unknown genotype at the D5S818 locus, given the reference and mixture data at all loci.

This section compares the results of five different mixture interpretation reviews. These reviews were conducted on STR data derived from the same DNA samples, but using different interpretation methods and reviewers. The conservative lab protocols were followed by two independent reviewers (government scientists A and B), the aggressive protocols were used by two different independent people (private lab scientists A and B), and the objective reviews were conducted by computer using the TrueAllele® Casework computer system (Perlin 2003).

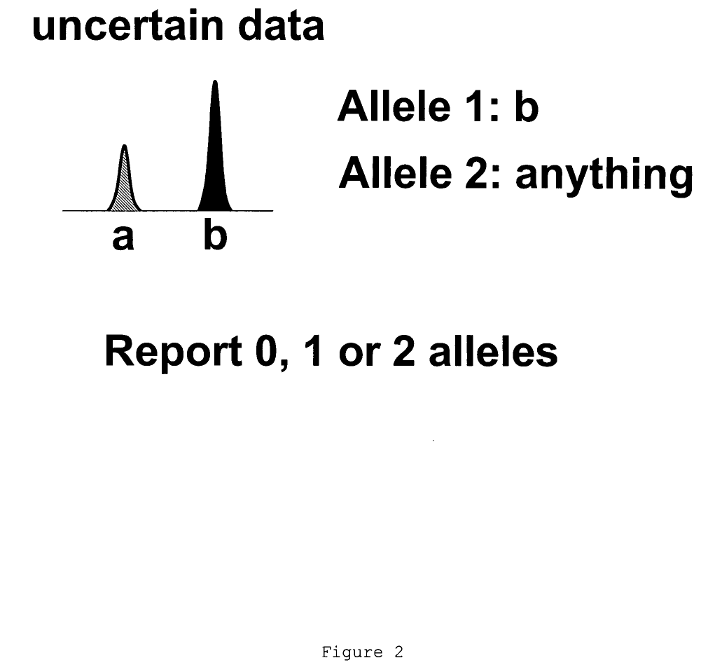

The “conservative” government review method for mixture interpretation is designed to avoid overcalling the DNA profile results. In the schematic example of data having an uncertain interpretation (FIG. 2), one of the alleles must have designation “b”. However, it is uncertain what the other allele is: it could be designated as “a”, as “b”, or even as something else. Therefore, this conservative protocol calls for reporting out 0, 1 or 2 alleles of which the examiner is entirely certain. The inferred profile here has allele 1 set to “b”, and allele 2 able to assume any value. This is indicated by the [b, *] allele pair designation, where * denotes a wild card symbol that can match any allele.

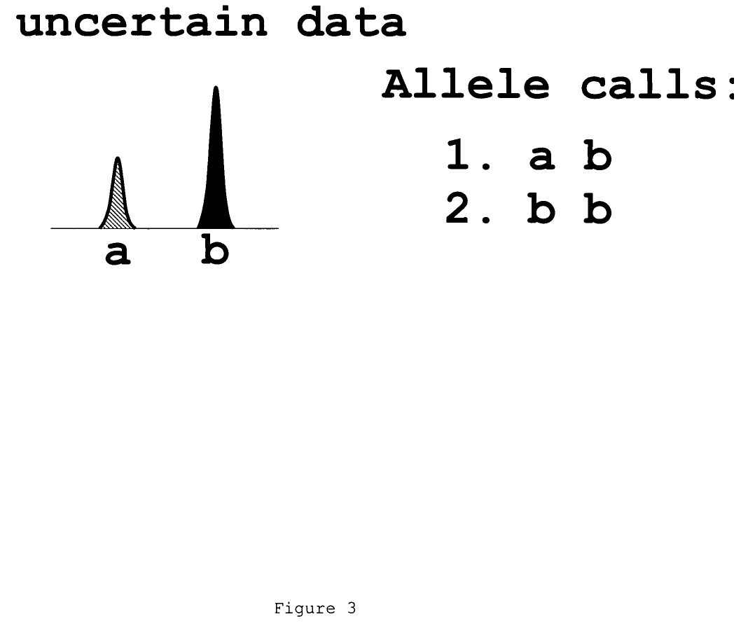

The “aggressive” private lab review method for mixture interpretation strives for more profile specificity by trying to rule out unlikely allele pair combinations. Referring to the uncertain data example (FIG. 3), there are two likely allele calls: the heterozygote [a, b] and the homozygote [b, b]. Any other allele pairs would be highly unlikely. This interpretation method reports a list of the likely allele calls.

The “objective” TrueAllele computer review method for mixture interpretation is designed to preserve match information (Perlin and Szabady 2001; Perlin 2004). It does this by reporting out a set of allele pairs, each having an associated probability (Perlin 2003). When the data are unambiguous, the method reports out just one allele pair with a probability of 1. With uncertain data, multiple allele pairs can be reported, having probability values which add up to 1. Note that this probability representation does not rank the allele pairs; rather, a contributor profile inferred from the mixture data is a probability distribution described by the allele pairs and their probabilities.

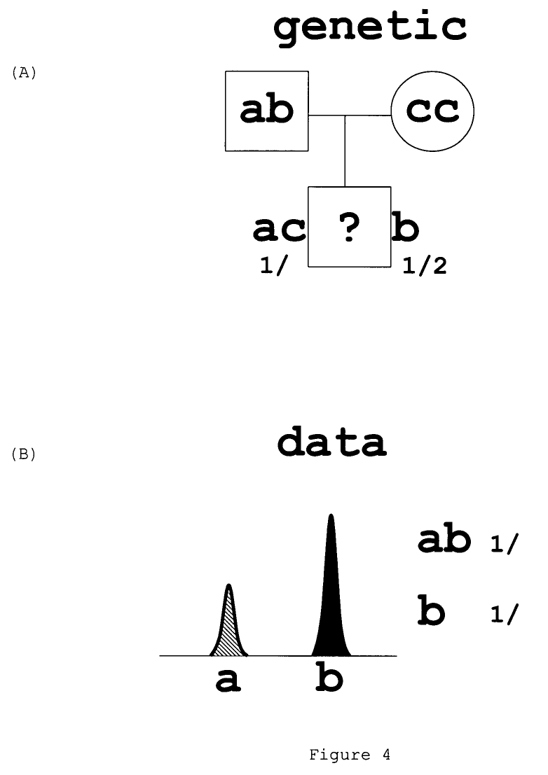

The use of allele probability distributions is common in genetic science. For example (FIG. 4A), following Mendelian inheritance in the example genetic pedigree, the parent genotypes of [a, b] and [c, c] would produce a child with a 50% chance of having genotype [a, c] and an equal chance of having genotype [b, c]. Over the last few decades, this statistical representation of genetic uncertainty has been used successfully with computers to find genes, develop diagnostic tests, and understand the underlying molecular mechanisms that can lead to curing disease (Lange, Weeks et al. 1988; Andrews, Devlin et al. 1997; Roeder, Escobar et al. 1998).

The data example (FIG. 4B) shows how TrueAllele computer interpretation of uncertain data can produce genotypes with probability. If allele calls [a, b] and [b, b] were both likely solutions, then they would both be included in the probability distribution, each having a probability that depended on the data. In this example, there is a hypothetical probability assignment of 0.5 to each of the two possibilities.

### Mixture Interpretation and Match Information

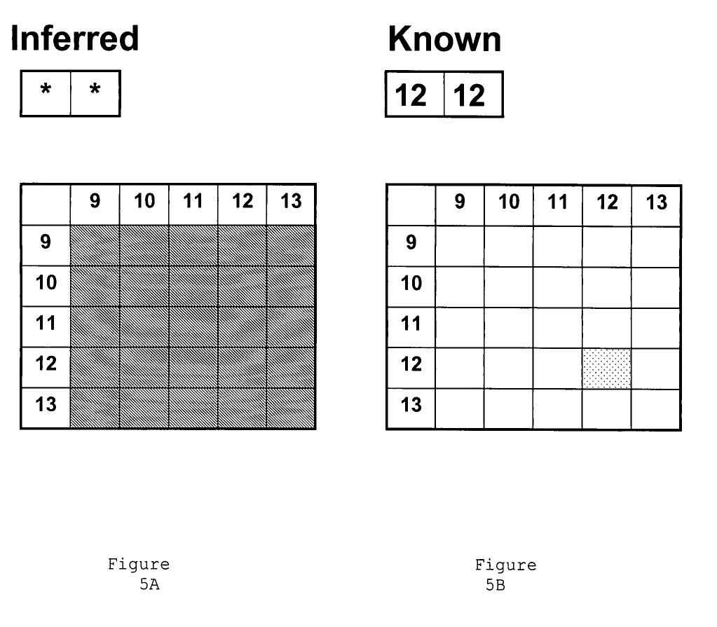

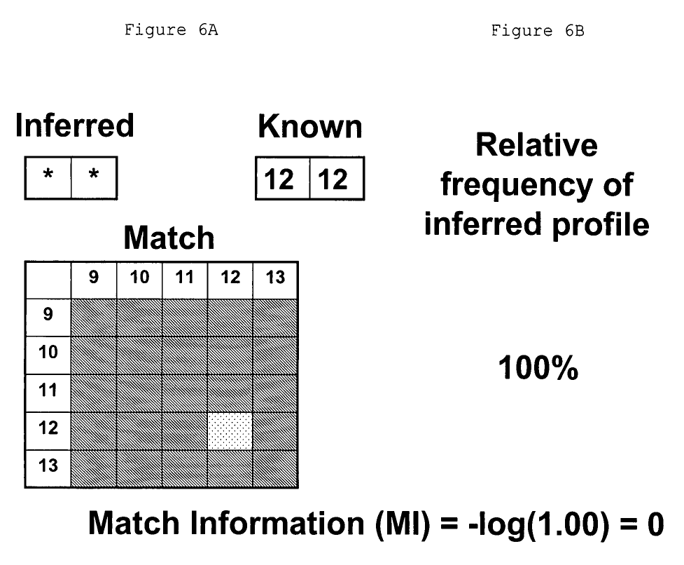

The first example case review to consider follows the “conservative” interpretation method, as conducted by government Reviewer A. For clarity, consider all four phases of forensic DNA comparison.
Phase 1: Infer DNA profile. The reviewer inferred that any genotype was possible, yielding the designation [*, *], where * denotes a wild card symbol that can match any allele. As shown (FIG. 5A) by the entirely filled in diagonal pattern Punnett square (Butler 2005), all allele pairs are possible.
Phase 2: Match with known. A match comparison can be made against the known genotype [12, 12]. As shown (FIG. 5B), this genotype is represented by the small stippled pattern square at allele coordinate [12, 12]. Looking at this figure, as well as the next (FIG. 6A), the diagonal pattern inferred set of all possible genotypes overlaps the stippled pattern [12, 12] known genotype, and so there is a match.
Phase 3: Relative frequency. The inferred profile [*, *] includes all possible genotypes. Therefore, the relative frequency of the inferred profile is 100% of the population (FIG. 6B), since everyone has some genotype.
Phase 4: Draw conclusions. Since the inferred profile matches everyone, there is no information in this match.

Quantitatively, one can express this fact by stating that the match information is equal to zero (since 100% of the population has a frequency of 1, and log(1)=0).

A scientist can calculate match information directly from the population frequencies. The match likelihood ratio (which fully describes the match information) can be roughly defined as the probability of observing a specific match divided by the probability of observing a random match. For profiles inferred from clean single source DNA, this is exactly the random match probability (RMP)—the reciprocal of the relative frequency. The Match Information (MI) statistic is obtained by calculating this likelihood ratio when matching the inferred profile against the true, known profile. To properly measure and add up information, it is useful to work with the logarithm of the likelihood ratio. To summarize then:

$$\begin{matrix}Match Information = log ( match likelihood ratio ) \\ = log ( \frac{Probability ( specific match )}{Probability ( random match )} )\end{matrix}$$

In the usual cases seen in current forensic practice, there is a specific match (so that the probability of the observed specific match is certainty, i.e., equal to 1) and the random match probability is the population frequency, so that the Match Information statistic becomes:

$$\begin{matrix}Match Information = log ( \frac{1}{population frequency} ) \\ = - log ( population frequency )\end{matrix}$$

since the logarithm of a reciprocal equals the negative of a logarithm. To summarize, for mixture interpretation validation, most DNA laboratories would calculate match information statistic at a locus from population frequency data using the formula:

Match Information=−log(population frequency)

(For clarity in this specification, base 10 logarithms are used throughout. That is, if y=10^{x}, then x=log₁₀(y). For example, when y is 1,000,000, i.e., y=10⁶, then x=log₁₀(10⁶)=6. For the reader unpracticed in the use of logarithms, it can be helpful to take the log base 10 by counting the number of zeros to the decimal point.)

The combined probability of exclusion (CPE) statistic can report on a match strength for complex DNA situation (e.g., with more than one contributor) based on just the evidence (DNA Advisory Board 2000). It is calculated by adding together in the RMP denominator the population frequencies of a set of genotypes formed as all possible allele pairs from a set of alleles present in the data.

A more informative statistic is the modified likelihood ratio (MLR), also known as the modified match probability estimate (MMPE). Like the CPE, it adds up in the RMP denominator the population frequencies of a set of genotypes. Unlike CPE, not all allele pairs need to be present; unfeasible combinations can be removed. This genotype pruning can reduce the genotype list, which can in turn reduce the sum of the population frequencies in the denominator, thereby increasing the match information.

A general match statistic that subsumes all these special cases of RMP, CPE and MLR match statistics will be described later on in this specification. In using the general match statistic, each match approach corresponds to a genetic profile having a probability distribution on a set of genotypes. With RMP, at every locus the genetic profile has one genotype with a probability of one. With CPE, at a given locus the genetic profile has multiple genotypes (one for each possible allele pair), each having a uniform probability of one over the number of allele pairs. With MLR, at a given locus the genetic profile has multiple genotypes (one for each of the feasible subset of genotypes), each having a uniform probability of one over the number of feasible genotypes.

### Different Mixture Interpretation Results

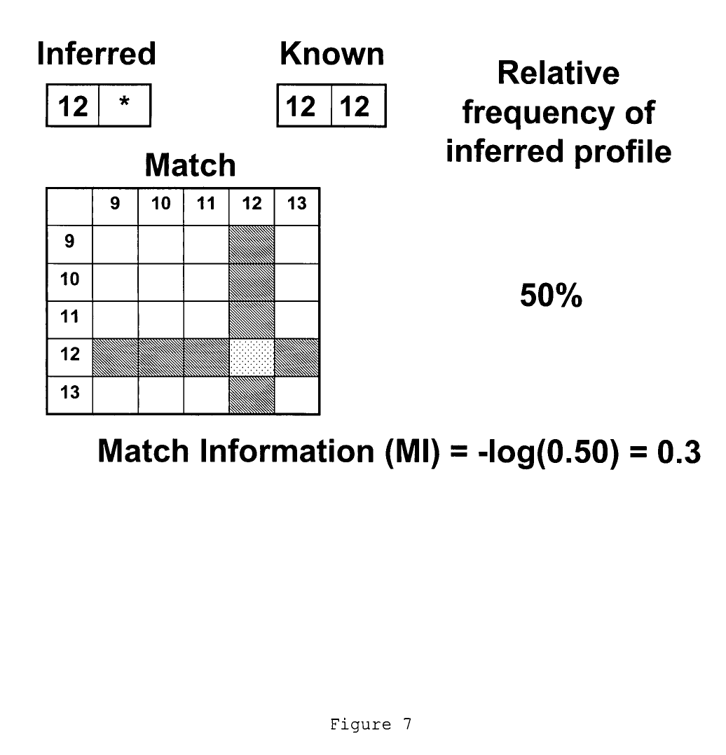

The second government reviewer B, looking “conservatively” at the same STR case data, inferred a different mixture profile at locus D5S818. Reviewer B inferred [12, *], specifying the first allele as 12, and leaving the second allele undesignated and free to match any allele. This inferred genotype is more specific than Reviewer A's [*, *] interpretation (FIG. 7), and it only matches those genotypes having at least one allele designated as 12. The increased specificity reduces the relative population frequency of the inferred profile from 100% down to 50%. The result is an increase in match information (computed as the negative logarithm of the population frequency 0.50) from zero up to 0.3.

The first private lab reviewer A, using a different “aggressive” mixture interpretation method, arrived at the same inferred [12, *] genotype as the “conservative” government reviewer B (FIG. 7). This replicated result has the same 50% relative frequency of the inferred profile and the same match information of 0.3.

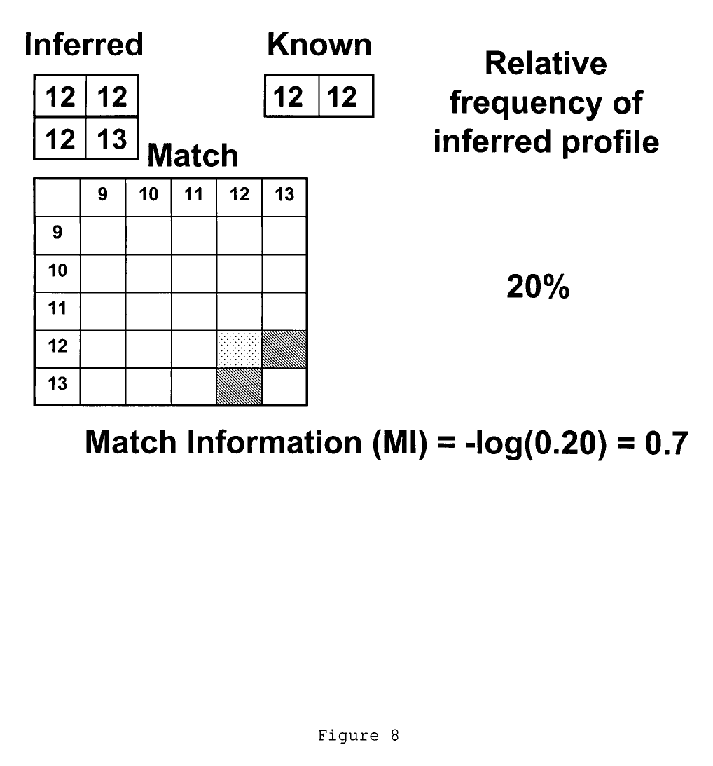

However, the second private lab reviewer B, “aggressively” inferred a more specific result, comprising the two allele pairs [12, 12] and [12, 13]. This increased specificity (FIG. 8) fills in even fewer of the Punnett square entries. The relative population frequency of Reviewer B's inferred profile is concomitantly reduced to 20%, with an increased match information of 0.7.

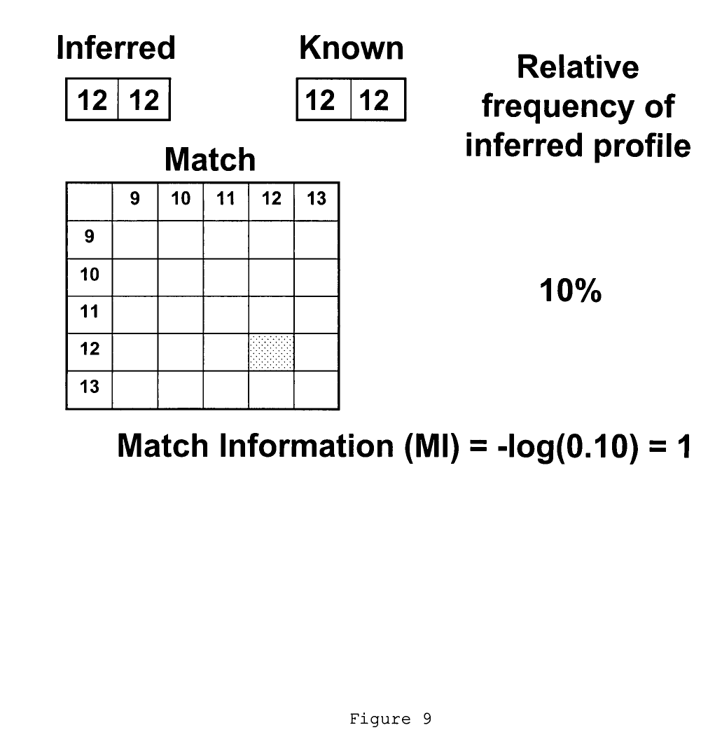

The TrueAllele “objective” computer review inferred only one answer, with probability one: [12, 12]. This is the most specific inferred profile, which exactly matches the known answer (FIG. 9). The increased specificity reduces the relative frequency of the inferred profile down to 10%, with an associated increase of match information to 1 (since −log₁₀(0.1)=+log₁₀(10)=1).

To obtain the match information for an entire inferred profile, simply add up the computed match information from every locus in the profile. (This works because of locus independence and the use of logarithms.) Combining the population frequencies in this additive way, one can write:

$$M {I}_{profile} = {\sum }_{locus} M {I}_{locus}$$

which means that the match information of the entire profile is equal to the sum of the match information at each of the loci.

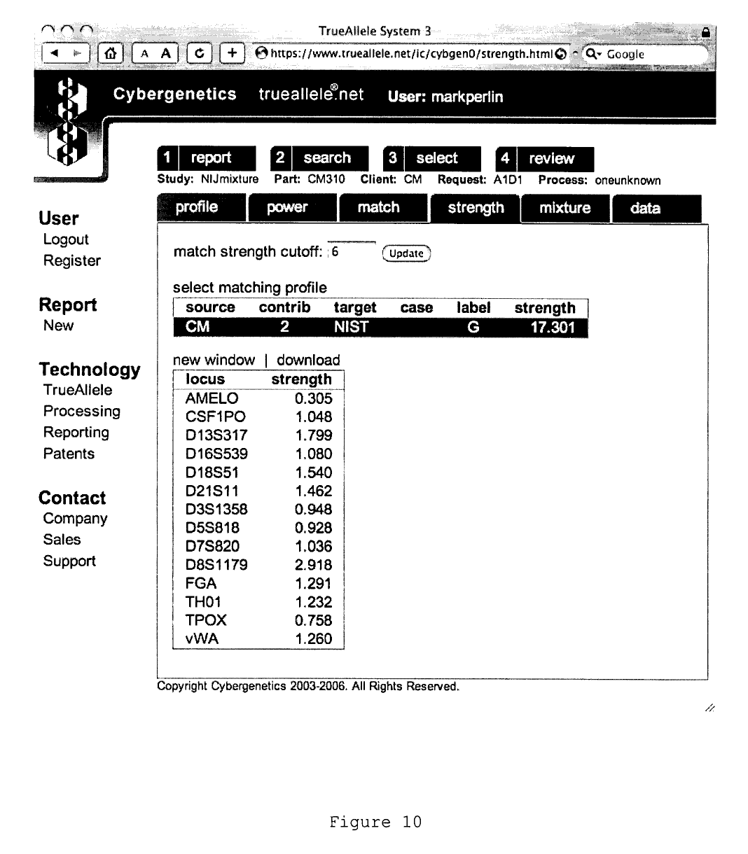

An example of how the individual locus match information values add up to the total profile match information can be seen for this case in the publicly accessible study section of the www.trueallele.net web site (FIG. 10).

### Scientific Validation of Mixture Interpretation

With five independent reviews for the D5S818 locus in this 50:50 mixture case, the reviewers inferred four different genotype solutions. These differences demonstrate that a concordance study between incommensurable profiles would not be possible. However, the match information statistic introduced above fully captures a profile's information content in ways that can be used for scientific validation. This section shows how efficacy (including accuracy and precision) and the critical reproducibility studies can be conducted based on this match information statistic.

The efficacy measures of accuracy and precision are described here as example measures because these are familiar to forensic scientists who perform laboratory data validations in accordance with DAB guidelines (DNA Advisory Board 2000). The reproducibility measure is perhaps the one more useful for scientific and legal reliability, and its characterization is an important result of this invention. An efficacy measure (such as accuracy) is also useful in validation studies, since a wholly inaccurate interpretation method for mixtures or other uncertain data would not be considered to be reliable. The precision measure of efficacy used here is just one of several possible reductions to practice, and helps motivate an efficacy statistic based on an average of differences.

These representative validation measures, and the entire family of possible scientific validation measures, are based on the match information (MI) value of an inferred profile. The ultimate legal use of an inferred DNA profile is the match information that it produces, so the MI statistic is quite appropriate for assessing the efficacy and reproducibility of forensic STR interpretation methods.

Inferred DNA profiles can be represented at a locus in different ways, including as lists of alleles, as lists of allele pair genotypes, and as probability distributions. These different representations, as well as the different answers within one representation, are often incommensurable (i.e., not directly comparable)—there is no logical way to compare the profiles. This incommensurability makes it impossible to conduct a concordance study based on direct profile comparison, whether between or within laboratories. However, regardless of its representation, the full profile has a match information relative to the true profile. This MI is just an ordinary one dimensional real number (and not a large, unwieldy profile representation), which can be compared against other MI numbers or used in mathematical formulas. These straightforward one dimensional profile MI numbers can be used in ordinary statistical measures of efficacy and reproducibility. The invention uses these match information values in statistical validation studies, instead of trying to work with the original unwieldy multi-dimensional profile representations.

The data set used in this section is taken from the two contributor cases previously described (Perlin 2003). Specifically, the studies describe here analyze “conservative” interpretation results from the 1 ng DNA mixture samples having 30%, 50%, 70% and 90% unknown contributors for two pairs of individuals. There were two reviews (A and B) performed for each of these eight cases. The match information (MI) statistic for each profile was computed in the TrueAllele Casework system using logarithms of population frequency, as described above and further elaborated upon in some of the following sections.

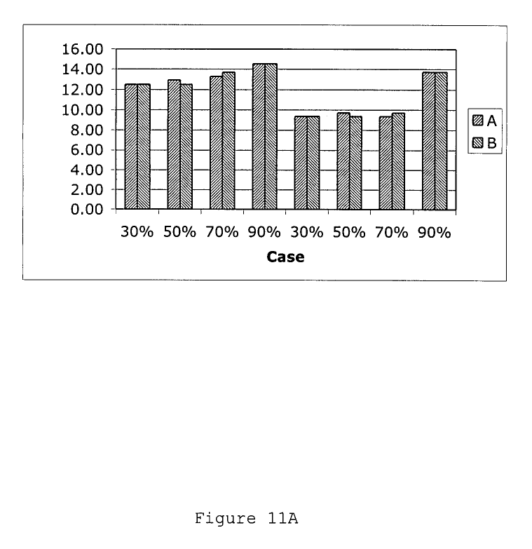

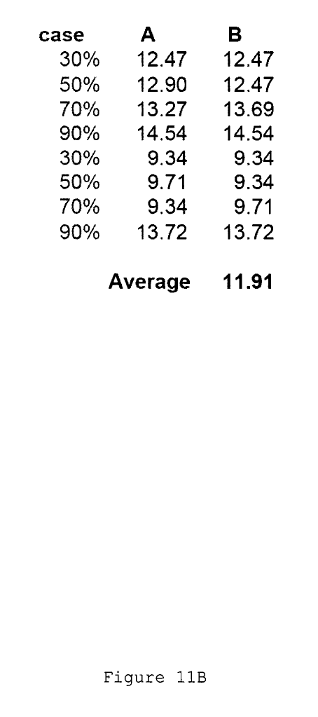

Accuracy is a measure of efficacy which asks the question of whether an answer is correct. Webster's dictionary defines accuracy as the “degree of conformity of a measure to a standard or a true value.” FIG. 11A shows a bar plot of the MI statistic for each pair of reviewer (A and B) inferred profiles, for all eight cases. It is visually apparent that the MI values lie between 9 (match likelihood ratio exceeding a billion to one) and 15 (match likelihood ratio exceeding a million billion to one). Therefore, on average, the inferred profiles are clearly identifying the correct individual.

This overall accuracy is a numerical reliability statistic that is well expressed through the average of the match information values for the N different case reviews:

$$\overline{M I} = \frac{1}{N} {\sum }_{i = 1}^{N} M {I}_{i}$$

which says that the average case match information ( M̅I̅) equals the sum of the match information for each case (MIᵢ), divided by the total number of cases (N). The case MI values taken from the Excel spreadsheet that generated the figure are shown (FIG. 11B). These cases have an average match information of 11.91, or roughly a likelihood ratio of one trillion to one (since log₁₀(1,000,000,000,000)=12).

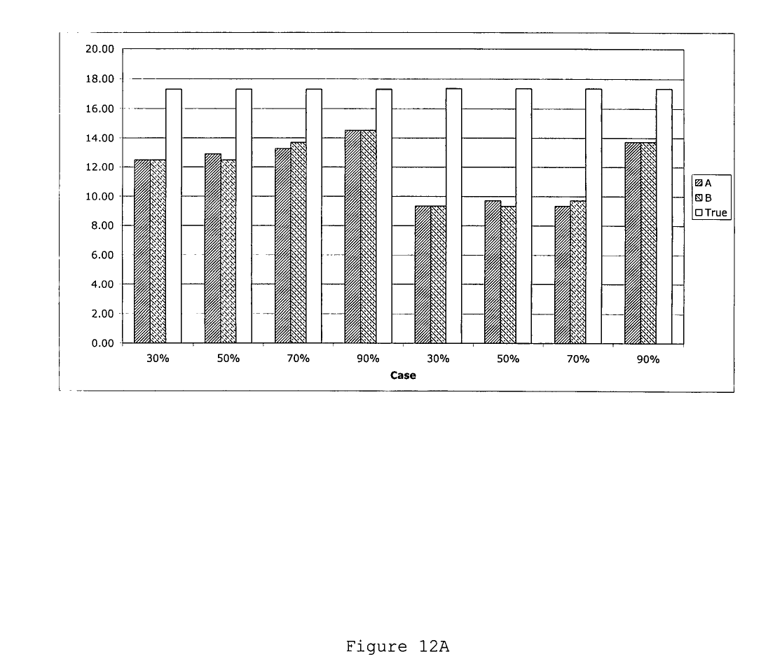

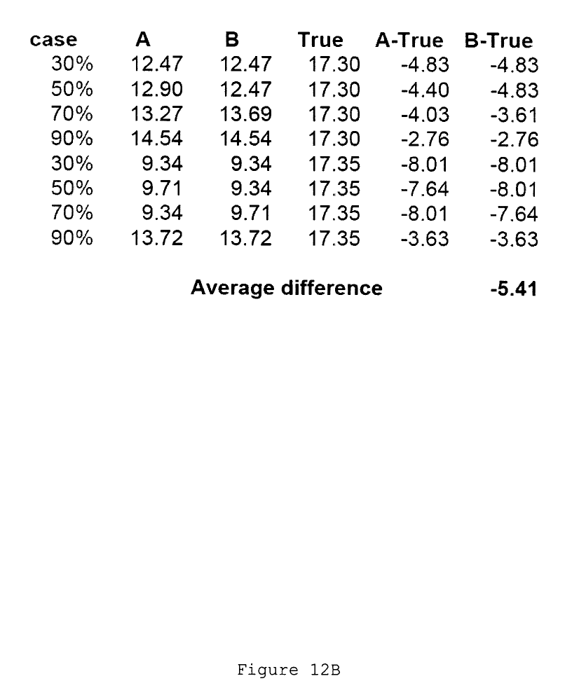

Precision is a measure of efficacy which asks the question of how precisely an answer is described. Webster's defines precision as “the degree of refinement with which an operation is performed or a measurement stated.” The match information statistic describes the number of significant digits that an inferred profile has attained in reaching the full discriminating power of a DNA profile. So in asking, “How close is this profile to the true profile?”, the difference between an inferred profile's MI and the true profile's MI provides a precise measurement of how close it is in each case. FIG. 12A shows a bar chart, similar to that in FIG. 11A, but now adding a bar within each case group that represents the MI of the true profile. The underlying data from this Excel spreadsheet are shown in FIG. 12B, along with the MI differences between the inferred and true profiles for every case.

A preferred embodiment of a measure of precision as a numerical reliability statistic for validating a mixture interpretation method is the average MI difference between inferred and true profiles:

$$\overline{Δ M I} = \frac{1}{N} {\sum }_{i = 1}^{N} ( M {I}_{i} - M {I}_{i}^{true} )$$

which says that the average case match information difference ( Δ̅M̅I̅) equals the sum of the match information differences between inferred and true for each case (MIᵢ−MIᵢ^{true}), divided by the total number of cases (N). These differences are computed and shown (FIG. 12B). For the “conservative” interpretation method in this validation example, the average MI difference is −5.41. Since log₁₀(1,000,000)=6, the inferred profiles are, on average, within a million to one likelihood ratio of the true answer.

Reproducibility is a numerical reliability statistic concerns the repeatability of an answer. Consider again the data plotted in FIG. 11A. Observe that the two reviewers, while not always generating exactly the same profile, are producing match information values that are very close in every case. This repeatability goes to the heart of the scientific validation of mixture interpretation methods, asking, “How repeatable is the solution?” The answer to this question squarely addresses the reliability of the DNA mixture interpretation process.

Scientists and statisticians often measure the reproducibility numerical reliability statistic through the preferred embodiment of a variance of a process (Bevington 1969). A most preferred embodiment of reproducibility represents the variance through its equivalent square root, the standard deviation, which preserves the original units. The standard deviation for the interpretation of mixture or other casework data is the average square deviation between the MI of a case and the average MI for that case.

The standard statistical formula for variance σ_{MI}² within case groups is:

$${σ}_{MI}^{2} = \frac{1}{N} {\sum }_{i = 1}^{m} {\sum }_{j = 1}^{{n}_{i}} {( M {I}_{i , j} - \overline{M {I}_{i}} )}^{2}$$

which says that the average case match information squared deviation (σ_{MI}²) equals the sum of the match information squared deviations between inferred and true for each case (MI_{i,j}− M̅I̅ᵢ)², divided by the total number of cases (N). Note that the variance here is measuring the variation between each individual review of a case (MI_{i,j}) relative to group average for all reviews of that particular case ( M̅I̅ᵢ).

(Remarks on notation: The subscript i refers to the i^{th} case, while the subscript pair i,j refers to the j^{th} review of the i^{th} case. The double summation

$${\sum }_{i = 1}^{m} {\sum }_{j = 1}^{{n}_{i}}$$

indicates that the N total reviews can be grouped into multiple reviews of m different cases. The i^{th} case has nᵢ separate reviews.)

The standard deviation σ_{MI} is defined in statistics as the square root of the variance:

$${σ}_{M I} = \sqrt{\frac{1}{N} {\sum }_{i = 1}^{m} {\sum }_{j = 1}^{{n}_{i}} {( M {I}_{i , j} - \overline{M {I}_{i}} )}^{2}}$$

The MI standard deviation σ_{MI} is helpful in understanding reproducibility because this numerical reliability statistic is expressed in the same units as match information. (The variance σ_{MI}², on the other hand, is a numerical reliability statistic that is scaled in the less intuitive “squared MI” units.)

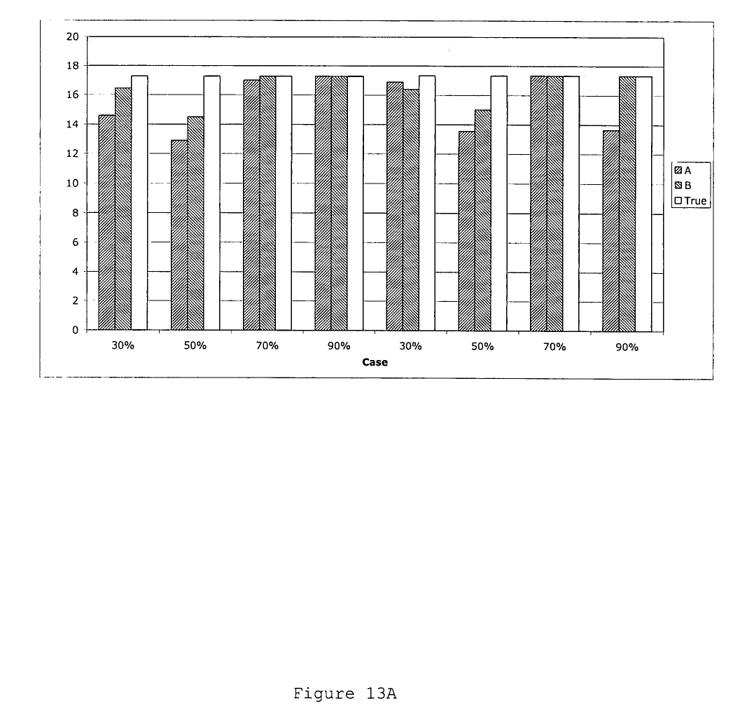

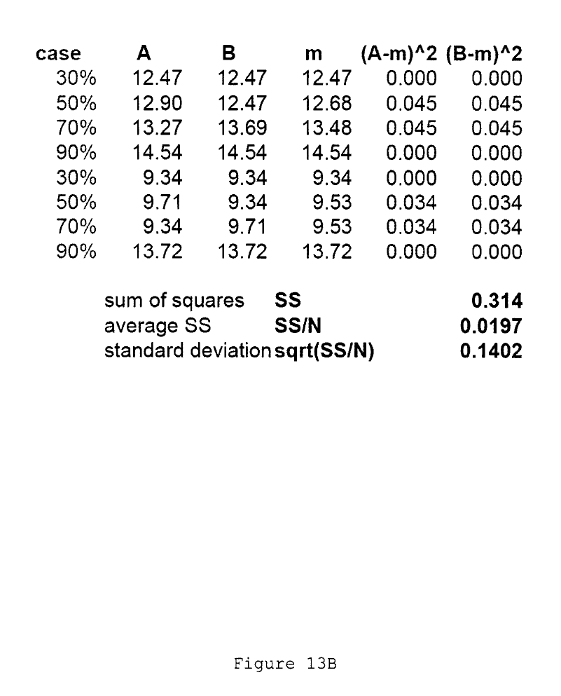

An Excel spreadsheet where each of the eight paired case reviews is shown in a separate row (FIG. 13B). The columns A and B provide the individual MI scores from Reviewers A and B for each case. The next column, labeled “m,” gives the average (or mean) value of the MI values recorded within each case. The last two columns in the spreadsheet compute the square deviation (MI_{i,j}− M̅I̅ᵢ)² between each reviewer's case match information MI_{i,j} and the average match information M̅I̅ᵢ for that case row.

At the bottom of the table, an entry adds up all the squared deviations to form the sum of squares SS. The estimated variance σ_{MI}², or average sum of squares, is calculated as SS/N. Finally, the estimated standard deviation σ_{MI} is computed as the square root of the variance. The resulting MI standard deviation equals 0.14, which is a small amount of MI variation relative to one logarithm unit of human identification. That is, the variation between multiple reviews of the same cases is very small. Hence, this “conservative” mixture interpretation method is quantitatively determined to be highly reproducible, with a known σ_{MI} reliability measured as 0.14 MI units.

### Comparison of Validation Results

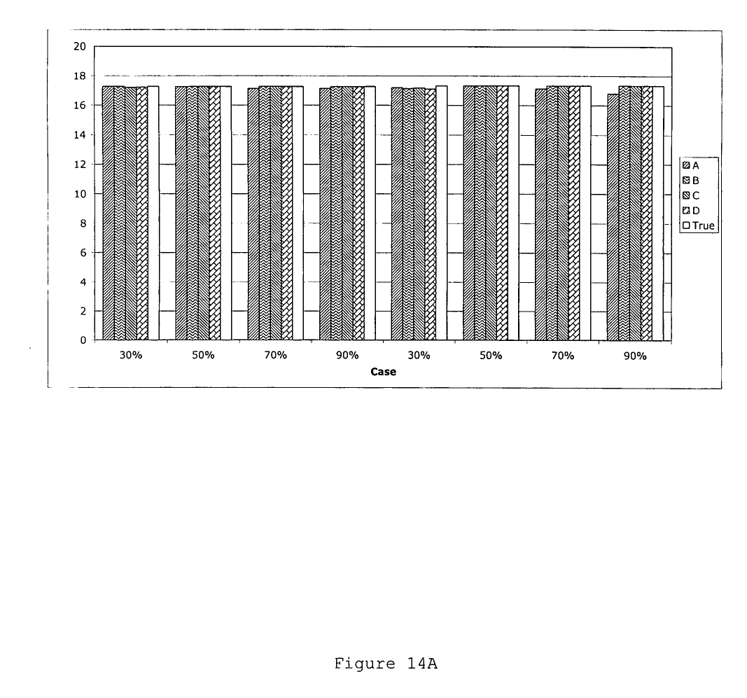

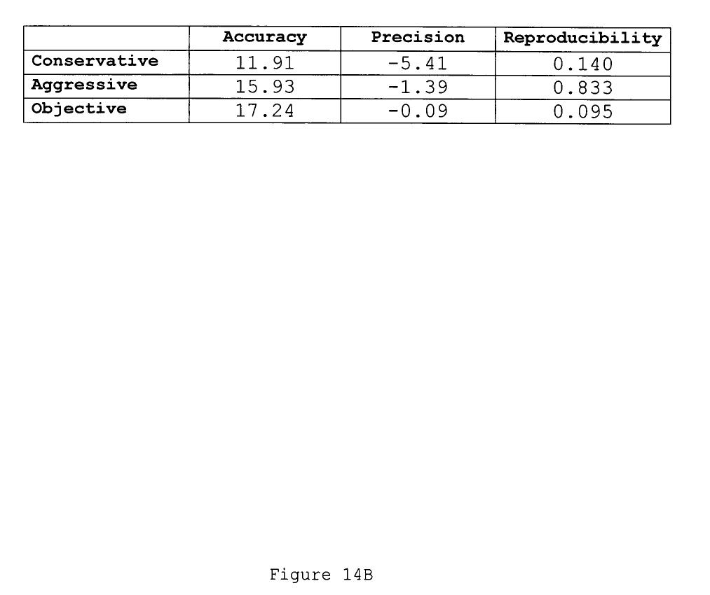

The validation results for three different mixture interpretation methods are shown in FIG. 14B. The first row, validating the “conservative” method, shows an accuracy of 11.91 match information units, a precision of −5.41 MI units, and a reproducibility of 0.140 MI units. These validation numbers do not in any way constitute a value judgment on the reliability of the interpretation method. However, by having these MI statistics available for presentation in court (particularly the all-important reproducibility determination), a laboratory can demonstrate that it has scientifically measured the reliability of its mixture interpretation method.

The match information comparison bar chart for the “aggressive” mixture interpretation method is shown in FIG. 13A. Each case cluster shows the MI statistic for reviewer A, reviewer B and the true profile. Visually, as compared with the “conservative” method, there appears to be more match information on average, but with greater variation between analysts' deduced profiles. This observation is borne out in the second row of FIG. 14B, where there is an improvement of 4 MI units for accuracy and precision, but a six-fold increase in MI standard deviation to 0.833, indicating a less reproducible process. Again, these MI validation statistics are neither good nor bad, but merely provide the scientific assessment of the method's reliability required by the court.

In comparing the “conservative” and “aggressive” mixture interpretation methods, one might ask if there is a fundamental trade-off between accuracy and precision on the one hand, and reproducibility on the other. That is, are more accurate interpretation methods inherently less reproducible? And does greater reproducibility imply lower precision? That might well be the case for the human interpretation of DNA mixture data. However, as demonstrated next, there is no such inherent limitation on statistical computer review.

The “objective” computer mixture interpretation method's match information comparison bar chart is shown in FIG. 14A. Each case cluster shows MI statistics for four different computer interpretation run profiles, and the true STR profile. (It is far easier to have a computer conduct multiple independent reviews of the same case than it is to ask people to perform this repetitive task.) There appears to be virtually complete match information, and very little variation between the interpretations. This observation is confirmed in the third row of FIG. 14B, where one observes virtually no loss of match information relative to the true profile (accuracy and precision), and a high reproducibility indicated by a standard deviation of less than 0.1 MI units. These data indicate that automated computer mixture interpretation methods are inherently amenable to rapid and complete scientific validation.

### Legal Admissibility and Scientific Validation

The law requires the admissibility of scientific evidence in order for it to be presented in court. This admissibility is based on the reliability of the proffered evidence, including the data, the method and the application of the method to the data (FRE 702). The reliability of these components is demonstrated by conducting validation studies that address jurisdictional requirements (Frye or Daubert).

In forensic DNA practice, interpretation methods for mixtures and other uncertain evidence have not been validated. This scientific gap is partially due to the absence of any rigorous method for validating the interpretation of complex DNA evidence. For example, conventional concordance studies used in forensic laboratories cannot work. However, the interpretation of mixture and other uncertain data must be validated in order to introduce DNA evidence in court without significant risk of successful challenge.

This invention remedies the scientific gap by presenting a new statistical approach for rigorously validating mixture interpretation methods. The invention uses match information (a likelihood ratio statistic based on population frequencies) to assess accuracy and precision. By measuring the standard deviation as a numerical reliability statistic between different reviewers within the same case, the invention can quantitatively determine the reproducibility of a mixture interpretation method.

The specification shows how to implement the statistical validation approach in a standard Microsoft Excel spreadsheet, without the use of proprietary software such as the TrueAllele system. Laboratories already perform multiple reviews of the same case, and use population statistics to quantitatively assess match information. It can take only a few hours to enter these match information results into a spreadsheet, and calculate the standard deviation to measure reproducibility. This calculation will validate the lab's mixture interpretation method, generating the scientific reliability results needed to refute admissibility challenges.

An Microsoft Excel spreadsheet implementation is one preferred embodiment of a system that has a computer program stored on a computer readable medium than can perform a first step of computing a match information statistic, and that can additionally perform a second step of computing a numerical reliability statistic from the match information statistic.

### Classical DNA Interpretation Theory

This section describes the current forensic science approach, the idealized “classical theory” of interpreting DNA evidence. The power of a forensic identification method lies in how well it can distinguish one individual from another. The ideal approach would employ a set of independent features, each of which has a quantifiable high discrimination power. For individuals and their biological specimens, short tandem-repeat (STR) DNA typing (Weber and May 1989; Edwards, Civitello et al. 1991) achieves this ideal.

### Genotypes

At an STR locus (genome location), an allele corresponds to the number of short DNA sequences that are repeated as adjacent units. An STR unit is a short stretch of DNA, typically having four or five base pairs for the STR loci used in forensic analysis. The phenotype (measurable trait) of an STR allele is the observed length of a labeled DNA fragment which encompasses the repeated units. The alleles are transmitted genetically from parent to child, so that an individual inherits two alleles at the locus. Combining all pairs of alleles in the population forms the set of possible genotypes at the locus.

STRs are believed not to be expressed in the physical makeup of a human being. Consequently, when genetic differences in the number of repeated units occur (e.g., by mutation), these new alleles can persist without significant evolutionary pressure. Typically, then, a population shows diversity with respect to the length of the STR.

Each genotype g has a relative frequency of occurrence p(g) which can be estimated from a sample of the allele population. One can view this frequency as an estimate of the probability p(g) of observing feature g in an individual selected at random from the population. A small probability p(g) denotes a rare genotype feature, which, when present, is useful in distinguishing between individuals in the population.

Given a genotype g, the probability of a randomly selected genotype h matching g is p(g). This match ratio is often expressed as the inverse of p(g)

$$\frac{1}{p ( g )} ,$$

so that larger values connotate greater power. The loci in an STR panel are chosen so that the assumption of independence is biologically plausible, typically by using loci on different chromosomes. Therefore, the probabilities of L loci can be multiplied together using the product rule to obtain a combined match ratio called the random match probability (RMP) multiplied together using the product rule to obtain a combined match ratio called the random match probability (RMP)

$$M R = \frac{1}{{\prod }_{l = 1}^{L} {p}_{l} ( {g}_{l} )} = {\prod }_{l = 1}^{L} \frac{1}{{p}_{l} ( {g}_{l} )} \qquad ( 1 )$$

The STR genotypes used in practice have a match ratio of around 10. When 15 loci are combined in a typical STR panel, the combined match ratio of a DNA profile typically exceeds a trillion. I.e., the probability of observing that combination of genotype features in a person randomly selected from the population is less than one trillionth.

Data

The STR laboratory process begins by extracting the DNA molecules from a biological specimen in a case. The extracted DNA is used as a template in a polymerase chain reaction (PCR) (Mullis, Faloona et al. 1986). This PCR amplification copies each targeted STR locus region, synthesizing millions of fluorescently labeled DNA molecules. These labeled DNA fragments are then size separated and fluorescently detected by a DNA sequencing machine. The DNA sequencer records a fluorescent emission signal over time from the electrophoretic separation of the fragments. Longer DNA molecules differentially migrate more slowly than shorter ones, and so are detected at a later time.

Each peak location (x-axis) in the sequencer time signal corresponds to one DNA fragment size, and estimates the fragment length (i.e., the number of base pairs in the amplified DNA molecule). The peak height (y-axis) is described by sequencer manufacturers in terms of “relative fluorescent units” (rfu), which estimate the quantity of DNA present for that peak's fragment size. In this way, the STR laboratory process transforms biological specimens into quantified DNA peaks.

The genetic profile data for a single individual with a DNA amplification having 15 STR loci (and 1 non-STR locus) is shown in FIG. 1B. The STR phenotypic trait variation is observed as different DNA fragment sizes. On the x-axis delineating length in base pair units, longer DNA molecules appear to the right of shorter molecules. In this typical single source profile data, at each STR locus one or two tall peaks are observed; each of these peaks corresponds to an allele length of the individual's genotype at the locus. Two chromosomes provide two alleles; when the alleles share the same length (homozygous) there is one main peak, when the alleles have different lengths (heterozygous) there are two main peaks.

There are data artifacts that routinely arise from the polymerase chain reaction (PCR) DNA amplification step. One is PCR stutter, where some of the amplified DNA product loses a repeat segment (Hauge and Litt 1993; Perlin, Lancia et al. 1995). This stutter DNA fragment appears in the data as an additional peak of relatively smaller height adjacent to, and to the left of, the main allelic peak. Stutter peaks can be observed in FIG. 1B in most of the STR panels. Another artifact is relative amplification, where shorter DNA fragments (having fewer nucleotides) tend to PCR amplify more efficiently than longer DNA fragments. When relative amplification occurs at a heterozygous locus (i.e., two different allele lengths), the two DNA fragments produce proportionately different peak heights in the data. Many other data imperfections are due to ordinary experimental data variation (background noise, peak height variation, sizing precision, etc.).

Genotyping, or allele calling, is the determination of an individual's two alleles at every locus. With the pristine STR data usually seen with single contributor reference samples, laboratory data artifacts do not interfere with calling the one genotype present in the data. With convicted offender or paternity reference samples, the self evident data permit DNA analysts to set thresholds which include or exclude peaks as data (SWGDAM 2000). When a peak exceeds this threshold (e.g., 100 rfu, on a scale of 0 to 10,000), it is taken to represent an allele. When it does not, it is ignored as background noise. With peaks close to the threshold height, practitioners often apply multiple thresholds to decide how to proceed (accept the allele call, repeat the experiment, etc.). Unless data artifacts or control samples suggest otherwise, the analyst generally assumes that the genetic profile contains one genotype from one individual.

### Assumptions

The classical STR interpretation practice for simple DNA data has been extensively tested and validated, and works extremely well when its assumptions are satisfied. It is useful to consider some of those assumptions.
One threshold fits all data. A threshold can be applied to the data peaks, separating the true peaks (over threshold) from the background artifacts and noise. Each lab determines its own peak threshold for their process, typically set around 100 rfu. Some labs use one threshold at a higher level for data matching, and a lower threshold for excluding individuals (SWGDAM 2000); for each distinct application, one threshold fits all the data.
One peak is one allele. When the sample has one contributor and clean data, the tall data peaks (i.e., those over threshold) correspond to the allele fragments, and the small peaks can be ignored. With a homozygous genotype (one allele) one peak is observed, while with a heterozygous genotype (two alleles) two peaks are observed.
One contributor. Exactly one individual is contributing DNA to the biological sample. The straightforward random match probability statistic (1) assumes exactly one contributor.
One sample. The data under consideration are limited to one DNA sample at a time. The sample data are not combined to infer a genetic profile.
One genotype. The genetic profile is unambiguous, and contains a single genotype. The (one or two) peaks of this unique genotype solution are clearly seen in the data.
One match. At a locus, the match compares the one genotype of an STR profile with the genotype of a second profile. When the genotypes are the same, there is an exact match; otherwise, there is not a match.

### Uncertain Data

Real casework data does not satisfy the assumptions of the classical DNA interpretation theory for single contributor samples. Just as with fingerprints, there is the ideal (all people have unique features) and then there is the reality—crime scene data comes from collected biological specimens, and is not drawn directly from known people. Specimens that are scraped off surfaces, or extracted from body cavities, often do not produce pristine STR profiles. Consider the characteristics of real STR data, in the context of the classical assumptions.
One threshold does not fit all data. In modern statistical inference, inferred results are conditioned on the observed data. Summarizing data using cutoff threshold values before starting data analysis can obscure the results. With low signal strength, cutting off some of the data peaks removes information from the data. STR data contains data artifacts, such as the commonly observed relative allele amplification and PCR stutter peaks. Moreover, after applying thresholds to the peaks, the original quantitative data that falls below the threshold is often not used.
One peak is not one allele. There is no reason to expect that in complex data the observed peaks are in exact correspondence with the genetic alleles. When there is a disproportionate mixture of two or more individuals, the heights of small artifactual peaks heights can exceed those of true allele peaks. This poses a danger in analysis, since applying an arbitrary cutoff can remove true allelic peak data, while retaining artifactual peaks as data.
Multiple contributors. Sexual assault evidence usually contains at least two contributors, including the victim and one perpetrator; in some cases there may be other contributors, as well. These data have many alleles, hence many allelic peaks, as shown in FIG. 1B. The pattern can look more like a jagged mountain range than like a simple signal having only one or two tall peaks.
Multiple samples. Real cases usually entail more than one biological sample. Even the simplest property crimes usually have at least two samples; complex cases can have far more. Some labs following classical interpretation guidelines prohibit the examination of data from more than one sample at a time, since they have no procedure for combining evidence. Yet the required statistical inference must take all the data into account.
Multiple genotypes. It would be nice if the genotype of each contributor could be inferred from data with absolute certainty. But when the data are uncertain, multiple answers become possible and the highly probable ones must all be listed. Statistical methods can quantify this uncertainty by associating a probability with each reported genotype.
Multiple matches. It is easy to compare a single genotype (at a locus) against another one—either they match or they do not. But with two lists of genotypes (at a locus), comparing the possibilities becomes more complex. Saying there is an “all or none” match when the lists share a common genotype, without quantitatively accounting for the evidential weight of the genotypes, reduces match information. But the match information drives the criminal justice applications of finding, convicting and exonerating individuals. Inappropriate deviations from the true quantitative match information may render DNA match evidence less relevant under FRE 403 (Faigman, Kaye et al. 2002).

### Genetic Profiles

In the presence of data uncertainty, there may not be a unique genotype which can be inferred for a contributor from the data. Rather, there may be a set of feasible genotypes that are consistent with the data and other knowledge. The different degrees of belief in these alternative genotypes can be described after analyzing the data by assigning a probability to each genotype candidate.

For a finite number of genotype possibilities, denote the set of genotypes as G={g}, over all genotype candidates g. Associated with the genotype set G is a probability function π:G→°, where 0≦π(g)≦1 for gεG, and

$${\sum }_{g ∈ G} π ( g ) = 1.$$

(□ is the set of real numbers.) Define a genetic profile Γ as the pair (G,π), where G is a genotype set and π is a probability distribution on G.

The probability of a given genotype g prior to observing DNA evidence is known as its prior probability, written as Pr₀(g). Using a mathematical model of the DNA data process, one can determine the probability of observing the data d, conditionally assuming some specific genotype value g. This conditional probability is called the likelihood, written as Pr(d|g). From the laws of conditional probability (Feller 1968), the probability of a genotype after having observed the genetic data is proportional to the likelihood multiplied by the prior genotype probability. This posterior probability is then

Pr(g|d)∝c Pr(d|g)·Pr₀(g).

This section begins by describing the prior probability Pr₀(g) of a genotype. It next shows the role of the likelihood function Pr(d|g) in characterizing the relationship between the genotype candidate and the DNA data. Finally, it forms the posterior genotype probability π(g)=Pr(g|d) by combining the prior genotype probability with the observed likelihood.

### Prior Probability

The frequency of any phenotypic trait in a biological population follows a natural probability distribution. With STR measurements in the molecular biology laboratory, the genotype within the DNA generates the observed phenotype. An individual's genotype at a genetic locus is comprised of two alleles, with each allele on a chromosome inherited from one parent. At a given locus, these alleles are assumed to be in approximate Hardy-Weinberg equilibrium (Hartl and Clark 2006) in the population, and so have a population frequency that associates a probability pₐ to each allele a. The genotype probability distribution p(g) of all allele pairs is well approximated by the pairwise product of the allele probabilities. This product leads to a homozygote [a,a] genotype probability of pₐ², and a heterozygote [a,b] probability 2pₐp_{b} (since there are two ways to inherit an [a,b] allele pair from parents). That is, the prior genotype probability is

$${Pr}_{0} ( g ) = \{ \begin{matrix}{p}_{a}^{2} , for homozygote g = [ a , a ] \\ 2 {p}_{a} {p}_{b} , for heterozygote g = [ a , b ]\end{matrix}$$

If an individual is selected at random from a population, one expects that the person's genotype at a locus would have an allele pair value with a probability equal to the population genotype frequency. This is the information about an individual prior to one's obtaining any STR data about them. Therefore, for a given genotype g, the prior probability Pr₀(g) is its frequency in the population distribution. Should one's belief in the relevant population allele frequency change, so too would their prior genotype probability.

### Likelihood Function

The genotype likelihood Pr(d|g) is the probability of the observed data experiments d, assuming a particular genotype g. There may be additional assumptions, as well, such as the value of other genotypes, statistical parameters or background information.

For a single source DNA sample, a perfect STR experiment at a locus would produce either one main peak (homozygote) or two (heterozygote). The probability Pr(d|g) of such data when assuming the correct genotype is 1, while the probability of the data given an incorrect genotype is 0.

When the data are less pristine, the lower allelic peaks and higher background peaks can introduce uncertainty. This data uncertainty translates into a nonzero likelihood for more than one genotype possibility. It may be difficult for a human analyst to determine quantitative likelihoods. However, this assignment is a task well-suited to statistical computation.

With uncertain data, it can be useful to perform multiple experiments and combine their likelihoods in order to obtain a more informative result. Suppose that N independent STR experiments are conducted on biological samples drawn from the same case. These experiments (perhaps each testing at one locus) produce a set of data {dₙ},1≦n≦N. Assuming conditional independence, the likelihood function for this data set can be written as a product of the individual component likelihoods, or

$$Pr ( d \vert g ) = {\prod }_{n = 1}^{N} Pr ( {d}_{n} \vert g ) .$$

Single source example. Clean single source (SS) DNA is used as reference samples in forensic casework and convicted offender databanks. The results should be entirely unambiguous, with uncertain experiments repeated in order to achieve certainty. At each locus experiment, a data reviewer employs an all-or-none likelihood function which can assume the value 1 for at most one genotype, and a 0 value at all other genotypes.

Compromised DNA example. Compromised SS DNA is observed in casework, and is found in homicide and mass disaster samples. At each locus, a data reviewer examines the experimental data to consider possibly more than one possibility, each assigned a 0 or a 1 likelihood value.

Multiple experiments example. With compromised SS DNA, multiple PCR experiments can be performed on the same sample. This experiment repetition is done, for example, with low copy number (LCN) DNA methods. These independent data can be combined into a single likelihood function in order to improve the overall likelihood information.

### Posterior Probability

After the data have been observed, one can compute the posterior genotype probability by combining the likelihood with the prior. With a set of feasible genotypes, there is produced a posterior probability Pr(g|d) of a particular genotype g which satisfies the proportionality

Pr(g|d)∝Pr(d|g)·Pr₀(g).

After normalizing the genotype probabilities to sum to 1 (also known as Bayes Theorem), one obtains a posterior probability distribution π over the genotypes. This normalization is done by dividing by the sum

$${\sum }_{h ∈ G} Pr ( d \vert h ) \cdot {Pr}_{0} ( h )$$

of the unnormalized probabilities over all the genotypes hεG. The posterior probability of a genotype is then

$$π ( g ) = Pr ( g \vert d ) = \frac{Pr ( d \vert g ) \cdot {Pr}_{0} ( g )}{{\sum }_{h ∈ G} Pr ( d \vert h ) \cdot {Pr}_{0} ( h )} .$$

When there are N independent experiments, the likelihood can be written as a product

$${\prod }_{n = 1}^{N} Pr ( {d}_{n} \vert g )$$

of the separate likelihoods. Therefore, one can combine the prior Pr₀(g), and all of the likelihood probability information, to obtain the posterior genotype probability

$$\begin{matrix}π ( g ) = Pr ( g \vert d = ( {d}_{1} , {d}_{2} , … , {d}_{n} ) ) \\ = \frac{( {\prod }_{n = 1}^{N} Pr ( {d}_{n} \vert g ) ) \cdot {Pr}_{0} ( g )}{{\sum }_{h ∈ G} ( {\prod }_{n = 1}^{N} Pr ( {d}_{n} \vert h ) ) \cdot {Pr}_{0} ( h )} .\end{matrix}$$

Single source example, continued. With a clean SS experiment data, at each locus the 0-or-1 likelihood can support at most one genotype choice. Therefore, there is only one nonzero term in the Bayes denominator, and the posterior probability is 1.

Compromised DNA example, continued. In a compromised SS locus experiment, the nonzero 0-or-1 likelihood values can produce multiple genotype probability terms. When there is a uniform prior genotype probability, with K genotype possibilities, the posterior probability of each genotype is 1/K.

Multiple experiments example, continued. When multiple PCR experiments are conducted on compromised SS DNA, within each locus the independent data can be combined in order to sharpen the genotype likelihood and posterior probability.

### Comparing Profiles

The purpose of obtaining forensic DNA profiles is to compare them, and determine the extent to which they match. Let us focus for now on one genetic locus. Suppose there is a genotype g from one source or individual, and a second genotype h from another. Define the genotype match function μ(g,h) which checks for the identity of this pair of genotypes as

$$μ ( g , h ) = \{ \begin{matrix}1 , & if g = h \\ 0 , & otherwise\end{matrix}$$

This match definition can be extended from a single genotype to a genetic profile describing sets of genotypes. Let Γ_{A}=(G,π_{A}) be a genetic profile for individual A on genotype set G with probability measure π_{A}. Similarly, let Γ_{B}=(G,π_{B}) be another genetic profile on the same set G of genotypes. The profile match probability μ(Γ_{A},Γ_{B}) between genetic profiles Γ_{A} and Γ_{B} is defined as the probability of a genotype match over the joint profile distribution π_{AB}(g,h), for all genotypes g,hεG. The double summation can be reduced to a simpler single summation by removing the nonmatching genotype terms as

$$\begin{matrix}μ ( {Γ}_{A} , {Γ}_{B} ) = {\sum }_{g ∈ G} {\sum }_{h ∈ G} μ ( g , h ) \cdot {π}_{AB} ( g , h ) \\ = {\sum }_{g ∈ G} μ ( g , g ) \cdot {π}_{AB} ( g , g ) + \\ {\sum }_{g ∈ G} {\sum }_{{h ∈ G}_{h \neq g}} μ ( g , h ) \cdot {π}_{AB} ( g , h ) \\ = {\sum }_{g ∈ G} 1 \cdot {π}_{AB} ( g , g ) + {\sum }_{g ∈ G} {\sum }_{{h ∈ G}_{h \neq g}} 0 \cdot {π}_{AB} ( g , h ) \\ = {\sum }_{g ∈ G} {π}_{AB} ( g , g )\end{matrix}$$

Assuming that the compared individuals have genotypes that are independent of each other (for example, they are not close relatives), then one can factor the joint probability of a shared genotype as a product of the component genetic profile probability functions

π_{AB}(g,g)=π_{A}(g)·π_{B}(g).

However, the genotypes of two individuals may depend on their common subpopulation, having a coancestry coefficient θ. Nonetheless, the joint probability can be still factored into component profile probabilities as

π_{AB}(g,g,θ)=π_{A}(g)·π_{B}(g)·ρ_{θ,g},

where ρ_{θ,g} is the coancestry correction factor described next.

When accounting for population substructure (Balding and Nichols 1994), identical genotypes may possibly share a common ancestry, and so they are not independent. Population geneticists define the coancestry coefficient θ as the probability that a random allele shared by two genotypes is identical by descent (Evett, Gill et al. 1998). This coefficient is generally small (Roeder, Escobar et al. 1998), unless there is overwhelming inbreeding within a population.

To account for substructure in the described match function, use an augmented joint probability distribution π_{AB}(g,g,θ) which includes θ as a parameter. When matching DNA profiles, it is helpful to factor this joint distribution into a product of the individual genetic profile probabilities π_{A}(g) and π_{B}(g). To effect this factorization, introduce a population substructure correction factor ρ_{θ,g} which depends on θ and the genotype g as

$${ρ}_{θ , g} = \{ \begin{matrix}\frac{[ ( 1 - θ ) {p}_{a} + 2 θ ] [ ( 1 - θ ) {p}_{a} + 3 θ ]}{{p}_{a} [ ( 1 - θ ) {p}_{a} + θ ] ( 1 + θ ) ( 1 + 2 θ )} , & g = [ a , a ] homozygote \\ \frac{[ ( 1 - θ ) {p}_{a} + θ ] [ ( 1 - θ ) {p}_{b} + θ ]}{{p}_{a} {{p}_{b} ( 1 + θ )}^{2}} , & g = [ a , b ] heterozygote\end{matrix}$$

A straightforward mathematical derivation then shows that the joint distribution at a matching genotype g can be factored as

π_{AB}(g,g,θ)=π_{A}(g)·π_{B}(g)·ρ_{θ,g}.

Therefore, the profile match probability of two genetic profiles is the sum of the product of the two profile probabilities at each genotype:

$$μ ( {Γ}_{A} , {Γ}_{B} ) = {\sum }_{g ∈ G} {π}_{A} ( g ) \cdot {π}_{B} ( g ) \cdot {ρ}_{θ , g} .$$

When not considering population substructure, one can ignore the correction factor ρ_{θ,g}, and use the simpler summation of genotype profile probability products

$$μ ( {Γ}_{A} , {Γ}_{B} ) = {\sum }_{g ∈ G} {π}_{A} ( g ) \cdot {π}_{B} ( g ) .$$

This result says that the genetic profile of each individual contains all of the information necessary for quantifying human identification. That is, the result is a probability distribution based on individual genotypes, rather than some more complicated joint distribution involving multiple individuals and their genotypes.

The loci used in standard autosomal STR panels are generally assumed to be genetically independent (e.g., most reside on separate chromosomes). Therefore, the profile match probability across multiple loci is the product of the individual locus match probabilities, and the result is the combined match probability

$$μ ( {Γ}_{A} , {Γ}_{B} ) = {\prod }_{l = 1}^{L} μ ( {Γ}_{A , l} , {Γ}_{B , l} ) .$$

Logarithms are a more natural representation for products and quotients. Indeed, sets of logarithms of these match probabilities have been found to follow a normal probability distribution (Perlin 2005). It is therefore convenient to use a logarithm representation; the conventional base in the biological sciences is 10. Since the log of a product is the sum of the logs, ones sees that

$$\begin{matrix}log ( μ ( {Γ}_{A} , {Γ}_{B} ) ) = log ( {\prod }_{l = 1}^{L} μ ( {Γ}_{A , l} , {Γ}_{B , l} ) ) \\ = {\sum }_{l = 1}^{L} log ( μ ( {Γ}_{A , l} , {Γ}_{B , l} ) )\end{matrix}$$

One can ask whether the match probability at a locus can ever be zero. To make such an assertion requires absolute certainty, so one would have to account for all sources of biological, biochemical, laboratory, computer and human error; this is not possible. Therefore, a laboratory may wish to determine the probability β of a match actually occurring, even when the estimated probability is zero (i.e., the false negative rate, or Type II statistical error). Approximating the Bayesian combination, the reported match value at a locus is then the greater of the computed match probability and β. In a preferred embodiment work, a value is conservatively set as β=0.001, or log₁₀(β)=−3. This bound has the effect of limiting the amount of information that a single locus can add to or subtract from the total match.

Single source example, continued. Suppose that clean SS DNA sample A produces a genetic profile Γ_{A} with posterior probability=1 for one genotype at each locus. Further suppose that a known individual B has an unambiguous profile Γ_{B} (i.e., a single genotype at each locus, having probability=1). If at some locus the genetic profiles of A and B are both Γ=(g,1), then at their common genotype g they both have a probability of 1. Thus the match probability of the single nonzero product term is 1.

Compromised DNA example, continued. Suppose that a compromised DNA sample A produces a genetic profile Γ_{A} at some locus with multiple genotypes G, each gεG having a positive probability π_{A}(g) less than 1. One can compare this profile Γ_{A} with that of a known individual B having an unambiguous profile Γ_{B}. Suppose Γ_{A} and Γ_{B} share a common genotype g, with A's probability of g equal to π_{A}(g)<1, and π_{B}(g)=1. The match probability of the single nonzero product term is π_{A}(g)·1, or π_{A}(g). Thus there is a match between A and B at the locus, but the strength of the match is reduced from 1 down to A's posterior probability π_{A}(g) at the matching genotype.

### Relative Frequency

A trait that is common in the population produces many matches between pairs of individuals. Therefore, the forensic identification question centers on the relative frequency of the match—how rare is the match event? To answer this question, it is necessary to consider the probability of a match between a genetic profile and a random person in the population. Then divide the specific match probability by the random match probability to obtain a measure of the relative frequency of the match.

To make this denominator more precise, consider the match ratio between the genetic profiles Γ of A and B relative to a random population R

$$MR ( A , B , R ) = \frac{μ ( {Γ}_{A} , {Γ}_{B} )}{μ ( {Γ}_{A} , {Γ}_{R} )} \qquad ( 2 )$$

For example, Γ_{A} might be a genetic evidence profile determined from a crime scene, and Γ_{B} a suspect's genetic profile. Γ_{R} is a random population genetic profile that summarizes the population genotype frequency. It is useful to have the ratio of the specific match (Γ_{A} vs. Γ_{B}) relative to the random match (Γ_{A} vs. Γ_{R}). The specification has already taught how to compute the match probability μ(Γ_{A},Γ_{B}), even when the genetic profile Γ_{A} (or Γ_{B}) is uncertain and only known as a probability distribution.

A useful attribute of genotype probability representation is that every genetic profile can be represented by a probability distribution. The evidence genetic profile Γ_{A} is sometimes highly uncertain. In some situations (as described later on), the suspect genetic profile Γ_{B} can be uncertain, as well. Importantly, the random population genetic profile Γ_{R} can be also represented as a genotype probability distribution, with the probability of each genotype determined by the population allele frequencies. Profile Γ_{R}=(G,π_{R}) has a probability distribution π_{R} which is the same as the genotype prior Pr₀(g) discussed above, namely, the frequency of genotype occurrence p(g) in the population. That is,

π_{R}(g)=Pr₀(g)=p(g)

The population distribution π_{R} can be treated mathematically just like any other genotype probability distribution. Therefore, one can determine the denominator μ(Γ_{A},Γ_{R}) by comparing the genetic profile probability functions π_{A} and π_{R} using a straightforward sum of products. The specification has already described how to compute the numerator match probability μ(Γ_{A},Γ_{B}), which compares profiles Γ_{A} and Γ_{B}. Therefore, one can determine the relative frequency of the match by forming the ratio of these two match probabilities. Taking logarithms (as above), define the match information statistic MI₁ at a locus as

$${MI}_{l} ( A , B , R ) = log ( \frac{μ ( {Γ}_{A , l} , {Γ}_{B , l} )}{μ ( {Γ}_{A , l} , {Γ}_{R , l} )} ) \qquad ( 3 )$$

The total match information MI is the sum of these individual locus MIᵢ terms

$$MI ( A , B , R ) = {\sum }_{l = 1}^{L} {MI}_{l} ( A , B , R ) = {\sum }_{l = 1}^{L} log ( \frac{μ ( {Γ}_{A , l} , {Γ}_{B , l} )}{μ ( {Γ}_{A , l} , {Γ}_{R , l} )} ) \qquad ( 4 )$$

Single source example, continued. With a clean SS profile A, all of the loci have a posterior probability equal to 1. Comparing against a known reference profile B (also with unique genotypes having probabilities of 1) yields a 1 match value in the numerator, and the population probability in the denominator. This ratio is just the conventional random match probability for single source DNA.

Compromised DNA example, continued. With compromised DNA, a locus may produce an ambiguous genetic profile Γ_{A}=(G,π_{A}) from the uncertain data. When compared with a reference profile Γ_{B}=(g,1), the match probability in the numerator has the single term π_{A}(g)·π_{B}(g) which is π_{A}(g)·1 or π_{A}(g). This value indicates how much the full match probability is reduced from 1. The denominator has sum of genotype products, combining each genotype probability π_{A}(g) with its frequency in the population π_{R}(g).

Discriminating power example. The discriminating power of genetic profile is a measure of its relative uniqueness. With single source DNA, there is exactly one genotype (with a probability of one) at each locus, and the discriminating power of A's genetic profile Γ_{A} is the same as its conventional random match probability (1). The match ratio (2) generalizes this measure to all genetic profiles, including those having multiple genotypes. Using this match ratio, the discriminating power is seen to be the match ratio of a profile against itself—letting the second profile B be the same as profile A, this is MR(A, A, R). Similarly, from (4), it is clear that the match information is MI(A, A, R).

Kinship matching example. An individual's genetic profile can be inferred from the genetic profiles of its relatives (Geyer and Thompson 1995; Thomas and Gauderman 1995; Sisson 2007), even in the absence of STR data for the individual. This genetic profile has a probability distribution that can be matched against other genetic profiles. In the MI match information statistic, the kinship-inferred genetic profile Γ_{K} may be used in either the evidence (left) or the reference (right) position.
For example, in a mass disaster where family references are available, setting Γ_{B}=Γ_{K} enables the matching of a scene profile Γ_{A} inferred from STR data against a reference profile Γ_{K} inferred from kinship genotypes using the statistic MI(A, K, R).
Conversely, in familial database searching, the genetic profile Γ_{K} of a relative of an individual leaving crime scene DNA evidence can be matched against a reference profile set {Γ_{B}} in a DNA database via MI(K, B, R).

Population distribution example (target). When the target profile Γ_{B} is the same as the random population Γ_{R}, i.e., Γ_{B}=Γ_{R}m the match information is zero. This is because the statistic's numerator μ(Γ_{A},Γ_{R}) is identical to its denominator μ(Γ_{A},Γ_{R}), and so the ratio is one and the logarithm is zero. That is, matching a genetic profile against an uninformative profile having the population distribution yields no useful identification information, yielding MI=0, as expected.

Population distribution example (source). When the source profile Γ_{A} is the same as the random population Γ_{R}, i.e., Γ_{A}=Γ_{R}, the expected match information is zero. This is because taking the π_{R} population average of the genetic profiles Γ_{B} with statistic MI(R, B, R) has an average value of MI(R, R, R), which (has identical numerator and denominator and) evaluates to zero. Therefore, on average, matching a highly uninformative genetic profile (which has genotype probabilities close to the population probabilities) yields no specific match information.

Database match example. A standard DNA match application is comparing a genetic profile Γ_{A} inferred from evidence STR data (e.g., obtained at a scene of crime or mass disaster site) against a set of genetic profiles {Γ_{B}} that populate a DNA database. In one preferred embodiment, this DNA database is comprised of convicted offenders who are likely suspects for other crimes. The match information statistic MI(A, B, R) is computed for the evidence genetic profile A against each of the database reference genetic profiles B relative to the random population distribution R. A highly likely “cold hit” match, as indicated by match information statistic, can suggest that the suspect B in the database may have been present at the scene of the crime.

### Capabilities of the Invention

The invention includes a method for determining a reliability of a forensic interpretation method comprising the steps of obtaining forensic data, a known feature, and a population of features. Then there is the further step of obtaining a forensic interpretation method that is applicable to the forensic data. Then there is the further step of applying the interpretation method to the forensic data to obtain an inferred feature. Then there is the further step of computing a match information statistic that determines a frequency of occurrence of a match between the inferred feature and the known feature relative to the population of features. Then there is the further step of computing a numerical reliability statistic from the match information statistic to determine the reliability of the forensic interpretation method for legal admissibility in a court of law.

The invention includes the method as described above where the forensic data includes biological evidence. It further includes the method as described above where the biological evidence includes DNA. It further includes the method as described above where the DNA is assayed by an STR experiment. It further includes the method as described above where the known feature is obtained by a match in a forensic case. It further includes the method as described above where each feature in the population of features has an estimated frequency of occurrence. It further includes the method as described above where the forensic interpretation method is a documented forensic protocol. It further includes the method as described above where the forensic interpretation method interprets DNA derived from a single individual. It further includes the method as described above where the forensic interpretation method interprets DNA derived from a mixture containing two or more individuals. It further includes the method as described above where the applying of the interpretation method to the forensic data is performed by a person. It further includes the method as described above where the applying of the interpretation method to the forensic data is performed by a computer.

The invention includes the method as described above where the match information statistic forms a ratio of a first probability of a specific match between the inferred feature and the known feature, and a second probability of a random match between the inferred feature and the population of features. It further includes the method as described above where the inferred feature in the match information statistic corresponds to one genotype. It further includes the method as described above where the inferred feature in the match information statistic corresponds to a plurality of genotypes.

The invention includes the method as described above where the numerical reliability statistic is used to validate the interpretation method for forensic use. It further includes the method as described above where the numerical reliability statistic assesses the efficacy of the forensic interpretation method. It further includes the method as described above where the numerical reliability statistic is related to an average value. It further includes the method as described above where the numerical reliability statistic assesses the reproducibility of the forensic interpretation method. It further includes the method as described above where the numerical reliability statistic is related to a standard deviation. It further includes the method as described above where the numerical reliability statistic of one group is compared with the numerical reliability statistic of another group.

The invention includes a method for comparing forensic features comprising the steps of inferring a first forensic feature. Then there is the step of inferring a second forensic feature. Then there is the step of obtaining a population of features along with their frequencies of occurrence. Then there is the step of computing a first probability of a specific match between the first feature and the second feature. Then there is the step of computing a second probability of a random match between the first feature and the population of features. Then there is the step of forming a match information statistic as a ratio of the first probability and the second probability for identifying an individual through a distinguishing feature.

The invention includes the method as described above where the first or second feature can be subdivided into a set of features, each of which is associated with a probability. It further includes the method as described above where the set of features corresponds to a set of genotypes. It further includes the method as described above where the first or second probability is determined by multiplying together the probabilities of features that match to form a product, and adding up the products to form a numerical value.

The invention includes a system that has a computer program stored on a computer readable medium comprising a first step computing a match information statistic that determines a frequency of occurrence of a match between an inferred feature and a known feature relative to a population of features, where the inferred feature is obtained by applying a forensic interpretation method to forensic data. Then there is a second step of computing a numerical reliability statistic from the match information statistic to determine the reliability of the forensic interpretation method for legal admissibility in a court of law.

### Other Applications

The invention described herein for determining a reliability of a forensic interpretation method comprises the steps of (a) obtaining forensic data, a known feature, and a population of features, (b) obtaining a forensic interpretation method, (c) applying the interpretation method to the forensic data, (d) computing a match information statistic that determines a frequency of occurrence, and (e) computing a numerical reliability statistic has general application.

The invention is not limited in any way to DNA identification. In one preferred embodiment for fingerprint analysis (Champod, Lennard et al. 2004), a forensic comparison can be performed by computing the probabilities of a specific match to an individual and a random match to a population of individuals, and forming a ratio. This ratio of probabilities can then be used in a match information statistic to determine the frequency of occurrence, hence the relative uniqueness of the fingerprint identification. From a set of fingerprint match information statistics, one can then compute a numerical reliability statistic to determine the reliability of a fingerprint comparison method in order to validate it and render its conclusions admissible in a courtroom.

Moreover, the invention is not limited in any way to forensic applications. The match information statistic can be used in any application involving any form of a comparison used to make an identification, and the numerical reliability statistic can be used to validate the identification method.

In another preferred embodiment, a match is made in the form of a hit to a web site using a method of inferring which sites compare most closely to specified Internet search objectives.

A first question arises regarding the specificity of this particular hit, which relates to the utility of the hit to the consumer or producer of the information. This first question can be answered completely by using the invention to compute a match information statistic for the hit. The statistic describes the relative uniqueness of a full or partial match, relative to a population of possible matches.

A second question concerns the efficacy and reproducibility of the Internet search method used to obtain the hit. This second question can be answered completely by using the invention to compute a numerical reliability statistic. This statistic can validate the search method, and determine its statistical reliability. This quantitative reliability metric is useful to consumers in their choosing which search method to use, to producers in their selection and refinement of search methods, and to investors in their determining which methods have the most efficacy.

### REFERENCES

The following citations have been referred to in this specification, and are incorporated by reference into the specification.
(1923). Frye v. United States, Court of Appeals of District of Columbia.
(1993). Daubert v. Merrill Dow Pharmaceuticals, Inc., Supreme Court. Andrews, C., B. Devlin, et al. (1997). “Binning clones by hybridization with complex probes: statistical refinement of an inner product mapping method.” Genomics 41(2): 141-154.
Balding, D. J. and R. A. Nichols (1994). “DNA profile match calculation: how to allow for population stratification, relatedness, database selection and single bands.” Forensic Sci Int 64: 125-140.
Bevington, P. R. (1969). Data Reduction and Error Analysis for the Physical Sciences. New York, McGraw-Hill.
Butler, J. M. (2005). Forensic DNA Typing: Biology, Technology, and Genetics of STR Markers. New York, Academic Press.
Butler, J. M. (2006). “Debunking some urban legends surrounding validation within the forensic DNA community.” Profiles in DNA 9(2): 3-6.
Champod, C., C. J. Lennard, et al. (2004). Fingerprints and Other Ridge Skin Impressions. Boca Raton, Fla., CRC Press.
DNA Advisory Board (2000). “Quality assurance standards for forensic DNA testing laboratories and for convicted offender DNA databasing laboratories.” Forensic Sci Commun (FBI) 2(3).
DNA Advisory Board (2000). “Statistical and population genetics issues affecting the evaluation of the frequency of occurrence of DNA profiles calculated from pertinent population database(s).” Forensic Sci Commun (FBI) 2(3).
Edwards, A., A. Civitello, et al. (1991). “DNA typing and genetic mapping with trimeric and tetrameric tandem repeats.” Am. J. Hum. Genet. 49: 746-756.
Evett, I. W., P. Gill, et al. (1998). “Taking account of peak areas when interpreting mixed DNA profiles.” J. Forensic Sci. 43(1): 62-69.
Faigman, D. L., D. H. Kaye, et al. (2002). Science in the Law: Forensic Science Issues, West Group.
Feller, W. (1968). An Introduction to Probability Theory and Its Applications. New York, John Wiley & Sons.
Geyer, C. J. and E. A. Thompson (1995). “Annealing Markov Chain Monte Carlo with applications to ancestral inference.” Journal of the American Statistical Association 90(431): 909-920.
Gill, P., C. H. Brenner, et al. (2006). “DNA commission of the International Society of Forensic Genetics: Recommendations on the interpretation of mixtures.” Forensic Science International 160: 90-101.
Hartl, D. L. and A. G. Clark (2006). Principles of Population Genetics. Sunderland, Mass., Sinauer Associates.
Hauge, X. Y. and M. Litt (1993). “A study of the origin of ‘shadow bands’ seen when typing dinucleotide repeat polymorphisms by the PCR.” Hum. Molec. Genet. 2(4): 411-415.
Kadash, K., B. E. Kozlowski, et al. (2004). “Validation study of the TrueAllele® automated data review system.” Journal of Forensic Sciences 49(4): 1-8.
Lange, K., D. E. Weeks, et al. (1988). “Programs for pedigree analysis: MENDEL, FISHER, and dGENE.” Genetic Epidemiology 5: 471-472.
Mullis, K. B., F. A. Faloona, et al. (1986). “Specific enzymatic amplification of DNA in vitro: the polymerase chain reaction.” Cold Spring Harbor Symp. Quant. Biol. 51: 263-273.
NDIS (2005). Appendix B: Guidelines for submitting requests for approval of an expert system for review of offender samples. DNA Data Acceptance Standards Operational Procedures, Federal Bureau of Investigation.
Perlin, M. W. (2003). Simple reporting of complex DNA evidence: automated computer interpretation. Promega's Fourteenth International Symposium on Human Identification, Phoenix, Ariz.
Perlin, M. W. (2004). Method for DNA mixture analysis.
Perlin, M. W. (2005). Real-time DNA investigation. Promega's Sixteenth International Symposium on Human Identification, Dallas, Tex.
Perlin, M. W. (2006). Scientific validation of mixture interpretation methods. Promega's Seventeenth International Symposium on Human Identification, Nashville, Tenn.
Perlin, M. W., G. Lancia, et al. (1995). “Toward fully automated genotyping: genotyping microsatellite markers by deconvolution.” Am. J. Hum. Genet. 57(5): 1199-1210.
Perlin, M. W. and B. Szabady (2001). “Linear mixture analysis: a mathematical approach to resolving mixed DNA samples.” Journal of Forensic Sciences 46(6): 1372-1377.
Roeder, K., M. Escobar, et al. (1998). “Measuring heterogeneity in forensic databases using hierarchical Bayes models.” Biometrika 85(2): 269-287.
Sisson, S. A. (2007). “Genetics: genetics and stochastic simulation do mix!” The American Statistician 61(2): 112-119.
SWGDAM (2000). “Short Tandem Repeat (STR) interpretation guidelines (Scientific Working Group on DNA Analysis Methods).” Forensic Sci Commun (FBI) 2(3).
Thomas, D. C. and W. J. Gauderman (1995). Gibbs sampling methods in genetics. Markov Chain Monte Carlo in Practice. G. W, R. S and S. D. Boca Raton, Fla., Chapman and Hall: 419-440.
Tobin, W. A. and W. C. Thompson (2006). “Evaluating and challenging forensic identification evidence.” The Champion 30(6): 12-21.
Weber, J. and P. May (1989). “Abundant class of human DNA polymorphisms which can be typed using the polymerase chain reaction.” Am. J. Hum. Genet. 44: 388-396.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A method for determining a reliability of a forensic interpretation method comprising the steps of:
(a) obtaining forensic data, a known feature, and a population of features;
(b) obtaining a forensic interpretation method that is applicable to the forensic data;
(c) applying the interpretation method to the forensic data to obtain an inferred feature;
(d) computing a match information statistic that determines a frequency of occurrence of a match between the inferred feature and the known feature relative to the population of features; and
(e) computing a numerical reliability statistic from the match information statistic to determine the reliability of the forensic interpretation method for legal admissibility in a court of law.

2. The method as described in claim 1 where the forensic data includes biological evidence.

3. The method as described in claim 2 where the biological evidence includes DNA.

4. The method as described in claim 3 where the DNA is assayed by an STR experiment.

5. The method as described in claim 1 where the known feature is obtained by a match in a forensic case.

6. The method as described in claim 1 where each feature in the population of features has an estimated frequency of occurrence.

7. The method as described in claim 1 where the forensic interpretation method is a documented forensic protocol.

8. The method as described in claim 3 where the forensic interpretation method interprets DNA derived from a single individual.

9. The method as described in claim 3 where the forensic interpretation method interprets DNA derived from a mixture containing two or more individuals.

10. The method as described in claim 1 where the applying of the interpretation method to the forensic data is performed by a person.

11. The method as described in claim 1 where the applying of the interpretation method to the forensic data is performed by a computer.

12. The method as described in claim 1 where the match information statistic forms a ratio of a first probability of a specific match between the inferred feature and the known feature, and a second probability of a random match between the inferred feature and the population of features.

13. The method as described in claim 12 where the inferred feature in the match information statistic corresponds to one genotype.

14. The method as described in claim 12 where the inferred feature in the match information statistic corresponds to a plurality of genotypes.

15. The method as described in claim 1 where the numerical reliability statistic is used to validate the interpretation method for forensic use.

16. The method as described in claim 1 where the numerical reliability statistic assesses the efficacy of the forensic interpretation method.

17. The method as described in claim 16 where the numerical reliability statistic is related to an average value.

18. The method as described in claim 1 where the numerical reliability statistic assesses the reproducibility of the forensic interpretation method.

19. The method as described in claim 18 where the numerical reliability statistic is related to a standard deviation.

20. The method as described in claim 1 where the numerical reliability statistic of one group is compared with the numerical reliability statistic of another group.

21. A method for comparing forensic features comprising the steps of:
(a) inferring a first forensic feature;
(b) inferring a second forensic feature;
(c) obtaining a population of features along with their frequencies of occurrence;
(d) computing a first probability of a specific match between the first feature and the second feature;
(e) computing a second probability of a random match between the first feature and the population of features; and
(f) forming a match information statistic as a ratio of the first probability and the second probability for identifying an individual through a distinguishing feature.

22. The method as described in claim 21 where the first or second feature can be subdivided into a set of features, each of which is associated with a probability.

23. The method as described in claim 22 where the set of features corresponds to a set of genotypes.

24. The method as described in claim 21 where the first or second probability is determined by multiplying together the probabilities of features that match to form a product, and adding up the products to form a numerical value.

25. A computer program stored on a computer readable medium comprising the steps of:
(a) computing a match information statistic that determines a frequency of occurrence of a match between an inferred feature and a known feature relative to a population of features, where the inferred feature is obtained by applying a forensic interpretation method to forensic data; and
(b) computing a numerical reliability statistic from the match information statistic to determine the reliability of the forensic interpretation method for legal admissibility in a court of law.
